(19) United States
(12) Patent Application Publication
(10) Pub. No.: US 2026/0194219 A1
(43) Pub. Date: Jul. 9, 2026

(54) LED LIGHTING DEVICE

(71) Applicant: JIAXING SUPER LIGHTING ELECTRIC APPLIANCE CO., LTD, Jiaxing (CN)

(72) Inventors: Qingquan Tong, Huanggang (CN); Kuan Lin, Jiaxing (CN); Mingbin Wang, Jiaxing (CN); Liao Wang, Jiaxing (CN); Qianlan Gong, Jiaxing (CN); Kun Zeng, Jiaxing (CN); Heng Zhao, Jiaxing (CN); Shaohua Liu, Jiaxing (CN)

(21) Appl. No.: 18/871,814

(22) PCT Filed: May 28, 2024
(86) PCT No.: PCT/CN2024/095631

§ 371 Date: Aug. 15, 2025

(30) Foreign Application Priority Data
May 29, 2023 (CN) 202310618028.0
Jul. 6, 2023 (CN) 202310830263.4
Sep. 28, 2023 (CN) 202311276415.7
Dec. 6, 2023 (CN) 202311659959.1
Dec. 8, 2023 (CN) 202311686098.6
Apr. 15, 2024 (CN) 202410451637.6
May 14, 2024 (CN) 202410595826.0

(51) Int. Cl. F21V 29/507; F21S 10/02; F21V 1/14; F21V 29/76; F21V 29/83; F21Y 105/10; F21Y 115/10

(52) U.S. Cl. CPC F21V 29/507; F21S 10/023; F21V 1/14; F21V 29/76; F21V 29/83; F21Y 2105/10; F21Y 2115/10

(57) ABSTRACT

Present invention provides a lighting device, including: a housing including a connecting portion with an accommodating space and two mounting portions disposed on two sides of the connecting portion respectively, each of the mounting portions includes an accommodating cavity; at least one heat dissipation channel is formed on one side of the mounting portion; one heat dissipation portion integrally formed with the mounting portion; a light-emitting element disposed in the accommodating cavity, and the light-emitting element and the heat dissipation portion are disposed on two sides of the mounting portion respectively; a power supply assembly disposed in the accommodating space; and a lampshade covered the light-emitting element and connected to the mounting portions, where the heat dissipation channel partially penetrates through the housing and is parallel to light direction of the lighting device, at least part of gas flowing in the heat dissipation channel flows through the mounting portions.

### PRIOR ART

This application is a national phase entry of International Application number PCT/CN2024/095631 filed on 2024 May 28, which claims Chinese priorities of Patent Application Nos. CN 202310618028.0 filed on 2023 May 29; CN 202310830263.4 filed on 2023 Jul. 06; CN 202311276415.7 filed on 2023 Sep. 28; CN 202311659959.1 filed on 2023Dec. 6; CN 202311686098.6 filed on 2023 Dec. 8; CN 202410451637.6 filed on 2024 Apr. 15 and CN 202410595826.0 filed on 2024 May 14; the disclosures of which are incorporated herein in their entirety by reference.

The present invention relates to the technical field of lighting appliances, in particular to an LED lighting device.

### BACKGROUND OF THE INVENTION

Lighting devices are commonly used in daily life, and include incandescent lamps, pendant lamps, linear industrial and mining lamps, etc. During operation of the lighting appliance, a light-emitting element of the lighting appliance will generate heat. With the increase of operating time of the lighting device, the heat accumulated by the lighting device will also increase, which will have adverse effects on the service life, performance, etc. of the lighting device, and may cause potential safety hazards.

One of the existing ways to dissipate heat of the lighting device is to increase the heat dissipation surface area of the lighting device, such as to increase the surface area of a housing connected to the light-emitting element in the lighting device. However, the further away the housing is from the light-emitting element, the worse the heat dissipation effect on the light-emitting element is. In order to meet the heat dissipation requirements of the lighting device, the lighting device needs a sufficiently large heat dissipation surface area, which also leads to a large size of the lighting device, is not conducive to packaging, transportation, and mounting, and will increase the cost of the lighting device.

The light-emitting surface and the backlight surface of a conventional lighting device are isolated from each other, and heat dissipation on two sides is carried out independently, which reduces the heat dissipation performance of the lighting device to some extent. How to design the heat dissipation structure of the lighting device and give consideration to the heat dissipation of the light-emitting surface and the backlight surface of the lighting device is an urgent problem to be solved.

### SUMMARY OF THE INVENTION

An objective of the present invention is to provide a housing for a lighting device, and a lighting device. The housing is configured to improve the heat dissipation performance of the lighting device and reduce the size of the lighting device.

The objective of the present invention is achieved by the following technical solution:

The present invention provides a lighting device, including:

a housing, where the housing includes a connecting portion and at least two mounting portions, the two mounting portions are disposed on two sides of the connecting portion respectively, the connecting portion has an accommodating space, and each of the mounting portions includes an accommodating cavity; at least one heat dissipation channel, where the heat dissipation channel is formed on at least one side of the mounting portion; a heat dissipation portion disposed on the mounting portion, where the mounting portions and the heat dissipation portion are integrally formed; a light-emitting element, where the light-emitting element is disposed in the accommodating cavity of the mounting portion, and the light-emitting element and the heat dissipation portion are disposed on two sides of the mounting portion respectively; a power supply assembly, where the power supply assembly is disposed in the accommodating space of the connecting portion; and a lampshade, where the lampshade covers the light-emitting element and is connected to the mounting portions; wherein the heat dissipation channel at least partially penetrates through the housing, and is parallel to a direction of light emitted by the light-emitting element, the heat dissipation channel completely penetrates through at least part of an area of the housing, the heat dissipation portion is disposed on one side of the mounting portion facing away from the light-emitting element, at least part of gas flowing in the heat dissipation channel flows through the mounting portions, and the heat dissipation portion includes a plurality of heat dissipation fins integrally formed with the mounting portions.

In an embodiment of the present invention, the light-emitting element includes a lamp board and a plurality of light-emitting bodies disposed on the lamp board.

In an embodiment of the present invention, the lamp board is provided with a conductive circuit, and the light-emitting bodies are electrically connected to the conductive circuit.

In an embodiment of the present invention, the mounting portion has a long edge and a short edge, and the heat dissipation channel is formed on one side of the long edge of the mounting portion.

In an embodiment of the present invention, the heat dissipation channel is formed on at least one side of the mounting portion and along the long edge of the mounting portion.

In an embodiment of the present invention, the heat dissipation channel is formed between the connecting portion and the mounting portion.

In an embodiment of the present invention, the heat dissipation fins are arranged at equal intervals along a direction of the mounting portion, and a direction of a thickness of the heat dissipation fins is parallel to a length direction of the mounting portion.

In an embodiment of the present invention, the power supply assembly is mounted on the connecting portion and supplies power to the light-emitting element.

In an embodiment of the present invention, the lighting appliance further includes a junction box, where the junction box is connected to the connecting portion by a connecting lug.

In an embodiment of the present invention, the lampshade includes a light processing unit, where the light processing unit includes a first optical member and a second optical member, same or different microstructure arrays are disposed on surfaces of the first optical member and the second optical member, and the microstructure arrays are micro convex or concave structures.

In an embodiment of the present invention, the lighting device further includes a hanging support member, wherein the hanging support member includes at least one first hanging support member and at least one second hanging support member, and the first hanging support member and the second hanging support member include at least one arc-shaped structure.

In an embodiment of the present invention, further comprises a first hanging support hole on one side of the housing and a second hanging support hole on the other side of the housing, wherein the first hanging support hole is corresponding to the first hanging support member and a second hanging support hole is corresponding to the second hanging support member are formed on the housing.

In an embodiment of the present invention, a dimming toggle button and a color adjustment toggle button are disposed on the connecting portion, and each of the dimming toggle button and the color adjustment toggle button has a plurality of adjustment gear positions.

The present invention provides a lighting device, including: a connecting portion, wherein the connecting portion is provided with a plurality of heat dissipation grooves; at least two mounting portions, each of the mounting portions includes light source mounting portions, and the light source mounting portions are movably connected to two sides of the connecting portion; a heat dissipation portion, wherein the heat dissipation portion is integrally formed with the light source mounting portions, the heat dissipation portion includes a plurality of heat dissipation fins, dissipating surfaces of the heat dissipation fins are perpendicular to a light-emitting surface of the lighting device, and the dissipating surfaces of the heat dissipation fins are parallel to each other and form air flow channels; a light-emitting element, where the light-emitting element is fixed to a surface of each of the light source mounting portions, and the light-emitting element includes a lamp board and light-emitting bodies disposed on the lamp board; and a lampshade, where the lampshade includes two first optical members and a second optical member, the first optical members are disposed on two sides of the second optical member and below the light source mounting portions, and the second optical member is disposed below the connecting portion.

In an embodiment of the present invention, the lighting device further includes first end caps and second end caps, where the first end caps are fixed to two ends of the connecting portion, the second end caps are fixed to two ends of the light source mounting portion, and each of the first end caps covers at least a part of each of the second end caps.

In an embodiment of the present invention, the first end cap includes a rotary connecting area configured to be connected to the second end cap, and the first end cap is connected to the second end cap by a rotary fixing structure.

In an embodiment of the present invention, the first optical members and the second optical member are independent of each other and spaced at a certain distance.

In an embodiment of the present invention, a gap is formed between the light source mounting portion and the connecting portion, and the width of the gap is greater than or equal to (√2-1)/2 times the thickness of the light source mounting portion.

In an embodiment of the present invention, wherein the first end cap comprises limiting teeth and limiting grooves, a limiting pillar is disposed on the second end cap, the limiting pillar is clamped with or separated from one of the limiting grooves by pulling, and when the limiting pillar is separated from the limiting groove, the light source mounting portion is rotatable relative to the connecting portion; and when the limiting pillar is clamped with the limiting groove, the light source mounting portion is fixed relative to the connecting portion.

In an embodiment of the present invention, the light source mounting portion includes a mounting bottom surface and a mounting groove formed by protrusions located on two sides of the mounting bottom surface and the mounting bottom surface, a plurality of mounting tracks disposed along a length direction of the lighting device are provided on the protrusions on the two sides, each of the mounting tracks has a bent portion, and the bent portion and the mounting bottom surface form a clamping space for clamping the light-emitting element.

Compared with the prior art, the present invention has at least the following beneficial effects:

The heat dissipation channel is formed on one side of the mounting portion, such that the gas flow in the heat dissipation channel can dissipate heat of the mounting portion, and the mounting portion can continuously absorb or conduct heat generated by the light-emitting element and effectively dissipate the heat to the outside, thereby improving the heat dissipation performance of the lighting device; a light-emitting angle is adjustable; moreover, the formation of the heat dissipation channel can improve the heat dissipation performance of the lighting device without increasing the heat dissipation area of the housing for the lighting device. Compared with an existing housing for the lighting device with the same heat dissipation effect, the housing is small in size, convenient to package, transport, and mount, and low in production cost.

### BRIEF DESCRIPTION OF DRAWINGS

FIG. 1 is a schematic diagram of a partial structure of a lighting device according to an embodiment of the present invention;

FIG. 2 is a schematic structural diagram of a lighting device according to an embodiment of the present invention from another perspective;

FIG. 3 is an enlarged view of a part A in FIG. 2;

FIG. 4 is a schematic structural diagram of a housing for a lighting device according to an embodiment of the present invention;

FIG. 5 is a schematic partial exploded view of a partial structure of a lighting device according to an embodiment of the present invention;

FIG. 6 is a partial planar sectional view of a lighting device according to an embodiment of the present invention;

FIG. 7 is a schematic structural diagram of a fixing member according to an embodiment of the present disclosure;

FIG. 8 is a schematic front view of an overall structure of a lighting device in an embodiment of the present invention;

FIG. 9 is a schematic exploded view (front) of a lighting device in an embodiment of the present invention;

FIG. 10 is a schematic diagram of a light-emitting element in an embodiment of the present invention;

FIG. 11 is a sectional view of a lighting device along a width direction in an embodiment of the present invention;

FIG. 12A is a schematic diagram of a lighting device after hiding of some components on a back surface of the lighting device in an embodiment of the present invention;

FIG. 12B is a schematic diagram of mounting positions of a light source mounting portion, a light-emitting element, and a heat dissipation portion in an embodiment of the present invention;

FIG. 13 is a top view of a lighting device in an embodiment of the present invention;

FIG. 14 is a schematic overall view of a lighting device in another embodiment of the present invention;

FIG. 15 is a schematic diagram of a lampshade in an embodiment of the present invention;

FIG. 16 is a view of a lighting device along a length direction in an embodiment of the present invention;

FIG. 17 is a schematic back exploded view of a lighting device in an embodiment of the present invention;

FIG. 18 is a schematic diagram of a light source mounting portion in an embodiment of the present invention;

FIG. 19 is a schematic diagram of a lighting device along a length direction of the lighting device after removal of second end caps in an embodiment of the present invention;

FIG. 20 is a separate schematic diagram of a connecting portion in an embodiment of the present invention;

FIG. 21 is a schematic diagram of a light-emitting element in an embodiment of the present invention;

FIG. 22A is a schematic diagram in which an angle between a light source mounting portion and a connecting portion is 90° in an embodiment of the present invention;

FIG. 22B is a schematic diagram in which an angle between a light source mounting portion and a connecting portion is −30° in an embodiment of the present invention;

FIG. 22C is a schematic diagram in which an angle between a light source mounting portion and a connecting portion is 60° in an embodiment of the present invention;

FIG. 23 is a schematic diagram of a lighting device in an embodiment of the present invention;

FIG. 24 is a schematic enlarged view of a part B in FIG. 23 in an embodiment of the present invention;

FIG. 25 is a schematic diagram of the back surface of the lighting device in this embodiment of the present invention;

FIG. 26 is a schematic exploded view of a lighting device in an embodiment of the present invention;

FIG. 27 is a schematic back view of a lighting device after hiding of a second optical member in the embodiment of the present invention;

FIG. 28 is a schematic diagram in which a lighting device is provided with a hanging support structure in an embodiment of the present invention;

FIG. 29 is a schematic diagram in which a lighting device is provided with a hanging support structure in another embodiment of the present invention;

FIG. 30 is a schematic diagram in which a lighting device is provided with two types of hanging support structures in an embodiment of the present invention;

FIG. 31 is a schematic back view of a lighting device in an embodiment of the present invention;

FIG. 32 is a schematic front view of a lighting device in an embodiment of the present invention;

FIG. 33 is a schematic diagram of one side of a light-emitting surface of a lighting device in an embodiment of the present invention;

FIG. 34 is a schematic diagram of a first optical member of a lighting device in an embodiment of the present invention;

FIG. 35 is a schematic back view of a lighting device in an embodiment of the present invention;

FIG. 36 is an enlarged view of a part E in FIG. 35 in an embodiment of the present invention; and

FIG. 37 is a schematic back view of a lighting device in an embodiment of the present invention.

In the drawings, 1: mounting portion; 10: light source mounting portion; 101: positioning plate; 102: light source mounting portion bottom plate; 103: light source mounting portion sidewall; 11: accommodating cavity; 12: hollow groove; 13: open ventilation window; 14: mounting groove; 140: mounting bottom surface; 141: mounting track; 15: hanging support member; 151: first hanging support member; 1510: first hanging support hole; 152: second hanging support member; 1512: second hanging support hole; 153: first connecting frame; 154: second connecting frame; 155: third connecting frame; 156: connecting rod; 157: locking disc; 1570: locking hole; 2: heat dissipation channel; 3: heat dissipation portion; 31: heat dissipation fin; 32: heat dissipation arc surface; 4: light-emitting element; 41: lamp board; 42: light-emitting body; 5: lampshade; 51: air vent; 52: first optical member; 53: second optical member; 530: heat dissipation hole; 531: sensor accommodating hole; 532: sensor; 54: end cap; 55: gap; 540: first end cap; 5400: rotary connecting area; 5401: arc-shaped open window; 5402: limiting tooth; 5403: limiting groove; 541: second end cap; 5410: end cap open window; 5411: limiting pillar; 6: fixing unit; 61: fixing portion; 611: fixing groove; 62: fixing member; 621: first connecting portion; 6211: first sidewall; 6212: second sidewall; 622: second connecting portion; 7: junction box; 71: wire outlet; 72: connecting lug; 8: power supply assembly; 9: connecting portion; 91: heat dissipation groove; 91′: heat dissipation groove; 910: dustproof eave; 92: bent portion; 93: dimming toggle button; 94: color adjustment toggle button; and 100: housing for lighting device.

### DETAILED DESCRIPTION OF THE INVENTION

The exemplary embodiments will now be described more fully with reference to the accompanying drawings. However, the exemplary embodiments can be implemented in various forms and should not be understood to be limited to the embodiments elaborated herein; and rather, these embodiments are provided so that the present invention will be more comprehensive and complete, and the concept of the exemplary embodiments will be fully communicated to those skilled in the art. Like reference signs in the figures denote identical or similar structures and thus repetitive descriptions thereof will be omitted.

The terms expressing the positions and directions described in the present invention are all illustrated using the accompanying drawings as examples, but may be subjected to changes as needed, all of which are included within the scope of protection of the present invention.

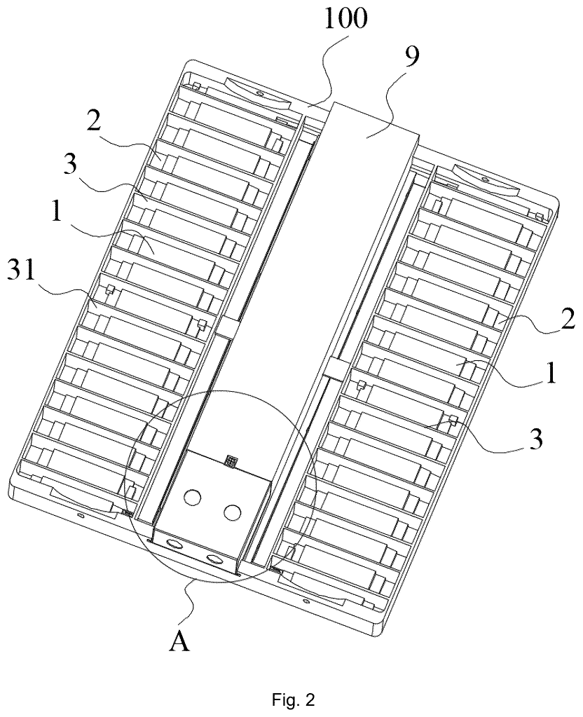

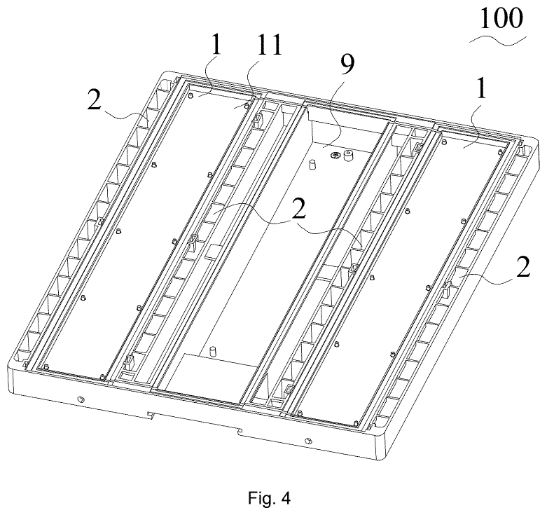

As shown in FIG. 2 and FIG. 4, a lighting device corresponding to an embodiment of the present invention includes a housing 100, where the housing includes at least one mounting portion 1, at least one connecting portion 9, at least one heat dissipation channel 2, and at least one heat dissipation portion 3.

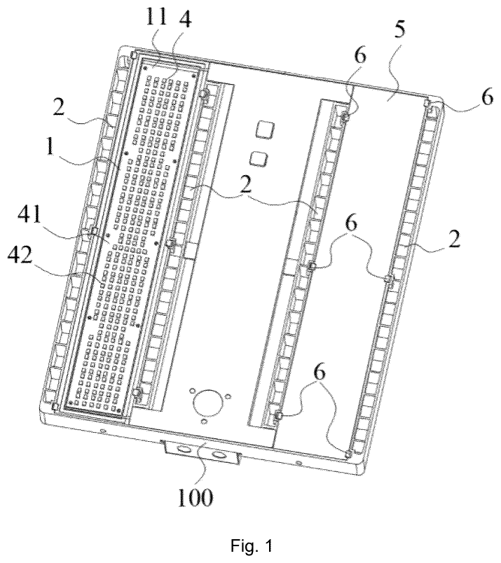

Further referring to FIG. 1, the mounting portion 1 is configured to be connected to a light-emitting element 4 in the lighting device. In order to facilitate mounting of the light-emitting element 4, the mounting portion 1 may be provided with an accommodating cavity for accommodating the light-emitting element 4, where a plurality of positioning columns are disposed in the accommodating cavity. The light-emitting element 4 may be provided with positioning holes capable of being fitly connected to the positioning columns. When the light-emitting element 4 is disposed in the accommodating cavity, the plurality of positioning columns can be fitly connected to the positioning holes preformed on the light-emitting element 4, so as to implement positioning of the light-emitting element 4. If the light-emitting element 4 is not provided with the positioning holes capable of being fitly connected to the positioning columns, when the light-emitting element 4 is disposed in the accommodating cavity, the plurality of positioning columns can also abut against an outer side of the light-emitting element 4, that is, the positioning columns are disposed on the periphery of a contour of the light-emitting element 4 in spatial position, such that the light-emitting element 4 is limited by the plurality of positioning columns in a similar interference fit manner, thereby implementing positioning of the light-emitting element 4. When the light-emitting element 4 is connected to the mounting portion 1, the mounting portion 1 can absorb or conduct at least part of heat generated by the light-emitting element 4 during operation in a heat transfer manner. One or more mounting portions 1 may be disposed. For example, a pair of mounting portions 1 is disposed, such that the housing 100 can be connected to two light-emitting elements 4, and at least part of the light-emitting element is accommodated in the accommodating cavity of the mounting portion.

The light-emitting element 4 may specifically include a lamp board 41 and a light-emitting body 42. The lamp board 41 can be connected to a power supply, and the lamp board 41 is formed with a conductive circuit. The light-emitting body 42 is electrically connected to the conductive circuit, such that the power supply can supply power to the light-emitting body 42 by the conductive circuit. A plurality of light-emitting bodies 42 may be disposed. In order to make light emitted by the light-emitting element 4 uniform, the plurality of light-emitting bodies 42 are distributed on the lamp board 41 at equal intervals. For example, when at least a part of the plurality of light-emitting bodies 42 are distributed in a rectangular area, the part of light-emitting bodies 42 can be distributed in a rectangular array; and a distance between any two adjacent light-emitting bodies 42 along a length direction of a rectangle is the same, a distance between any two adjacent light-emitting bodies 42 along a width direction of the rectangle is the same, or in order to further improve the uniformity of the light emitted by the light-emitting element 4, the distance between any two adjacent light-emitting bodies 42 along the length direction of the rectangle is the same as the distance between any two adjacent light-emitting bodies 42 along the width direction of the rectangle. When at least a part of the plurality of light-emitting bodies 42 are distributed in a round area, the part of light-emitting bodies 42 can be distributed in a ring array along the center of a circle; and a distance between any two adjacent light-emitting bodies 42 along a circumferential direction is the same, a distance between any two adjacent light-emitting bodies 42 along a radius direction of the circle is the same, or the distance between any two adjacent light-emitting bodies 42 along the circumferential direction is the same as the distance between any two adjacent light-emitting bodies 42 along the radius direction of the circle. The plurality of light-emitting bodies 42 in one light-emitting element 4 may all be distributed in an array in a rectangular area or an annular area, or a part of the light-emitting bodies 42 are distributed in an array along a rectangular area or an annular area, and another part of the light-emitting bodies are distributed in an array along another rectangular area or annular area. The light-emitting body 42 is preferably a lamp bead or an LED chip.

In some embodiments, in order to achieve a specific lighting effect, the light-emitting bodies 42 may also be unevenly distributed on the lamp board 41, that is, the number of the light-emitting bodies 42 in unit area of at least a part of the area is greater/less than the number of the light-emitting bodies 42 in unit area of another part of the area; in other words, the distribution density of the light-emitting bodies 42 in at least one area is greater than the distribution density of the light-emitting bodies 42 in at least another area.

The heat dissipation channel 2 is formed on at least one side of the mounting portion 1 (or the housing 100), and gas flow can be performed in the heat dissipation channel 2. At least part of gas flowing in the heat dissipation channel 2 can flow through the mounting portion 1 to dissipate heat of the mounting portion 1, such that during operation of the light-emitting element 4, at least a part of the mounting portion 1 can maintain a temperature lower than that of the light-emitting element 4 and continuously absorb or conduct the heat generated by the light-emitting element 4.

In an embodiment of the present invention, the heat dissipation channel 2 at least partially penetrates through the housing 100. In a direction perpendicular to the mounting portion 1 or parallel to light emitted by the lighting device, at least part of an area of the housing 100 is completely transparent and unobstructed, that is, the heat dissipation channel 2 completely penetrates through at least a part of the housing 100 or the lighting device, such that the heat dissipation channel 2 can better meet the requirement of gas convection.

The light-emitting element 4 in the lighting device is generally disposed close to a light-emitting surface of the lighting device, such that the light generated by the light-emitting element 4 can propagate to the outside as much as possible. Accordingly, most of the heat generated by the light-emitting element 4 during operation is aggregated near the light-emitting surface of the lighting device. In the design of the lighting device, the conventional design ensures that a main body (also known as the housing) of the lighting device covers the light-emitting element when the lighting device is in an operating state, and relative to the light-emitting element, the main body of the lighting device is disposed on the light-emitting element in an inverted manner, such that the heat generated by the light-emitting element during operation will be blocked to a certain extent by the main body of the lighting device to be accumulated. In order to effectively dissipate the heat of the lighting device, the heat dissipation channel 2 can specifically extend from the light-emitting surface of the lighting appliance to a backside surface of the lighting device, such that at least part of gas in heat dissipation channel 2 can flow from the light-emitting surface of the lighting device to the backside surface of the lighting device to take the heat at the light-emitting surface of the lighting device to the backside surface with a low temperature in the lighting device, and ultimately dissipate the heat out of the lighting device, thereby improving the heat dissipation efficiency of the lighting device.

The gas flow in the heat dissipation channel 2 may be performed through exchange between hot and cold air. Specifically, when the light-emitting element 4 operates, a temperature around will be increased, that is, air near the light-emitting element 4 will turn into hot air, and the hot air will rise due to an increase in volume and a decrease in density. The lighting device is usually disposed at a high position such as a ceiling, and the light-emitting surface thereof faces downward, that is, the backside surface of the lighting device is higher than the light-emitting surface thereof. When rising, the air at the light-emitting surface of the light-emitting element 4 moves to the backside surface of the lighting device and continues to spread outwards at the backside surface of the lighting device; and the air at the light-emitting surface of the light-emitting element 4 quickly spreads from a back surface of the lighting device along the heat dissipation channel 2, such that at least part of an area near the light-emitting element 4, namely, near the light-emitting surface forms a relatively thin air area, that is, a low-pressure area is formed, the air with a low temperature in the environment will naturally fill the vicinity of the light-emitting element 4, and the heat generated by the light-emitting element 4 is absorbed and continues to be dissipated from the heat dissipation channel 2, thus forming a complete air circulation.

The heat dissipation channel 2 is preferably disposed on a long edge of the mounting portion 1, and a short edge of the mounting portion 1 may not be provided with the heat dissipation channel 2, such that the size of the housing 100 for the lighting device is reduced while the heat dissipation performance of the lighting device is improved. The reason is that the formation of the heat dissipation channel 2 will inevitably require the housing 100 to extend a part of structure outwards from one side of the heat dissipation channel 2 along the mounting portion 1 to form the heat dissipation channel 2, which will increase the size of the housing 100, that is, the overall size of the lighting device. Only the long edge of the mounting portion 1 is provided with the heat dissipation channel 2, such that the length of the heat dissipation channel 2 along a length direction of the housing can be approximately the same as the length of the long edge of the mounting portion 1, that is, the heat dissipation channel 2 is longer. The heat dissipation channels and the light-emitting bodies 42 are distributed along a length direction of the mounting portion and matched with each other. Along the length direction, the heat dissipation channel 2 is provided around each light-emitting body 42, and the overall arrangement width of the light-emitting body 42 along the width direction is small, such that the light-emitting body 42 located in the middle of the width direction can also undergo heat dissipation from the heat dissipation channel 2, the overall heat dissipation effect is also good, and high heat dissipation benefits are achieved. In addition, when the heat dissipation channel 2 is formed on the short edge of the mounting portion 1, the heat dissipation effect of the heat dissipation channel is worse than the heat dissipation effect of the heat dissipation channel 2 on the long edge of the mounting portion 1. With regard to the distribution of the light-emitting bodies 42, the arrangement number of the light-emitting bodies in the length direction is much greater than the arrangement number of the light-emitting bodies in the width (short edge) direction. When the heat dissipation channel 2 is formed along the width (short edge) direction, only the light-emitting body 42 near the short edge can be subjected to heat dissipation by the heat dissipation channel 2. As the long edge is originally longer than the short edge, the light-emitting body 42 disposed along the long edge cannot be subjected to heat dissipation by the heat dissipation channel formed on the short edge, resulting in low heat dissipation benefits and an increase in the size of the housing 100 for the lighting appliance. Further, the heat dissipation channel 2 formed along the long edge can also dissipate heat of the light-emitting body 42 near the short edge. Accordingly, the heat dissipation channel 2 is formed only on the long edge of the mounting portion 1, which can effectively improve the heat dissipation performance of the lighting device and reduce the size of the lighting device (or the housing 100). In other words, the increased size of the lighting device (or the housing 100) is reduced as much as possible while the heat dissipation requirement is met. It is to be pointed out that, as needed, the heat dissipation channel 2 may be further formed on the short edge of the mounting portion 1 to further improve the heat dissipation performance of the lighting appliance.

The mounting portion 1 may specifically include a pair of opposite long edges. The heat dissipation channel 2 may be formed only on one long edge of the mounting portion 1 of the housing 100, or the heat dissipation channel 2 may be formed on each long edge of the mounting portion 1. Preferably, in order to improve the heat dissipation effect and balance the heat dissipation effect on two sides of the mounting portion 1, the heat dissipation channels 2 are formed on a pair of long edges of the mounting portion 1.

Further referring to FIG. 2, the heat dissipation portion 3 is connected to the mounting portion 1, and the heat dissipation portion 3 can absorb or conduct at least part of heat of the mounting portion 1, such that the heat dissipation portion 3 can absorb or conduct at least part of the heat generated by the light-emitting element 4 by the mounting portion 1; and the disposal of the heat dissipation portion 3 can effectively increase the heat dissipation area of the housing 100 for the lighting device. At least a part of the heat dissipation portion 3 is located in the heat dissipation channel 2, such that at least part of the gas flow in the heat dissipation channel 2 can flow through the heat dissipation portion 3 to dissipate heat of the heat dissipation portion 3.

The heat dissipation portion 3 is disposed on one side of the mounting portion 1 facing away from the light-emitting element 4, that is, the heat dissipation portion 3 and the light-emitting element 4 are disposed on two opposite sides of the mounting portion 1. In other words, the heat dissipation portion 3 is disposed on a back side of the mounting portion 1, and the light-emitting element is disposed on a light-emitting side of the mounting portion 1, so as to prevent the heat dissipation portion 3 from blocking out the light generated by the light-emitting element 4. The heat dissipation portion 3 may specifically include a plurality of heat dissipation fins 31, where the plurality of heat dissipation fins 31 are arranged apart from each other along a length direction of the mounting portion 1, and a thickness direction of the heat dissipation fins 31 is parallel to the length direction of the mounting portion 1, that is, the heat dissipation fins 31 are roughly perpendicular to a plane where the mounting portion 1 is located, and are parallel to the short edge of the mounting portion 1. Preferably, the plurality of heat dissipation fins 31 are arranged at equal intervals, such that the heat dissipation portion 3 composed of the plurality of heat dissipation fins 31 uniformly absorbs or conducts heat of all parts of the mounting portion 1. For lighting devices with different heat dissipation requirements, the number and height of the heat dissipation fins 31 can be adjusted correspondingly. For example, when the heat dissipation requirement is high, the number of the heat dissipation fins 31 can be increased, and/or the height of the heat dissipation fins 31 can be increased; or when the heat dissipation requirement is low, the number of the heat dissipation fins 31 can be reduced, and/or the height of the heat dissipation fins 31 can be reduced.

In another embodiment of the present invention, the thickness direction of the heat dissipation fins 31 is perpendicular to the length direction of the mounting portion 1, that is, the heat dissipation fins 31 are disposed along the length direction of the mounting portion 1 (or the power supply assembly).

In an embodiment of the present invention, the heat dissipation fins 31 (also known as the heat dissipation portion 3) are integrally formed with the mounting portion 1 or the housing 100.

In an embodiment of the present invention, the heat dissipation fins 31 (also known as the heat dissipation portion 3) are formed separately and then mounted on the mounting portion 1, or the heat dissipation fins 31 are formed separately and then assembled with the housing 100.

The connecting portion 9 is configured to mount the power supply assembly (not shown) capable of supplying power to the light-emitting element 4, that is, the connecting portion 9 is provided with a corresponding accommodating space, and at least part of the power supply assembly is disposed in the accommodating space. When only one mounting portion 1 is disposed, the connecting portion 9 can be disposed on one side of the mounting portion 1. When at least two mounting portions 1 are disposed, for example, in an embodiment, when there are two mounting portions, the connecting portion 9 can be disposed between the two mounting portions 1, that is, the two mounting portions 1 are disposed on two sides of the connecting portion 9 respectively, such that the power supply assembly mounted on the connecting portion 9 can simply and conveniently supply power to a pair of light-emitting elements 4 connected to the two mounting portions 1. The mounting portion 1 and the connecting portion 9 can be integrally formed from the same material, or formed independently of each other before assembly.

In an embodiment, the heat dissipation channel 2 is formed between the mounting portion 1 and the connecting portion 9, and can simultaneously dissipate heat of the connecting portion 9 and the mounting portion 1 located on two sides of the heat dissipation channel 2 respectively.

In order to further improve the heat dissipation performance of the lighting device, the housing 100 of the lighting device is made by using a die-casting process. The parts formed by die casting usually have a large surface area, which can increase the heat dissipation area of the housing 100 of the lighting device. Moreover, the die-casting formation can reduce pores and bubbles inside the parts, improve the heat conduction efficiency of the parts, and enhance the heat dissipation performance of the housing 100. The mounting portion 1, the connecting portion 9, the heat dissipation channel 2, and the heat dissipation portion 3 are preferably of an integrated structure, such that the housing 100 can be formed by using an integrated die-casting process. There is no spacing between the parts, that is, heat conduction between the parts is not obstructed, such that the heat generated by the heating components of the lighting device during operation can be quickly conducted to a non-heating position, thereby further improving the heat dissipation performance. As shown in FIG. 1 and FIG. 2, the present invention further provides a lighting device, including the above housing 100, at least one light-emitting element 4 for generating a light source, a power supply assembly, a junction box 7, and a lampshade 5.

The disposal of the housing 100 reduces the size of the lighting device, thereby enabling the lighting device to have a high lumen-area ratio. For example, the lumen of the lighting device in the present invention may be controlled between 30,000 Lm and 36,000 Lm; and the light-emitting area thereof is 80.6 mm*355.6 mm, which is 0.02866136 m², so the lumen-area ratio of the lighting device in the present invention may be 1,046,705.39 Lm/m² to 1,256,046.47Lm/m². In some other embodiments of the present invention, the lumen-area ratio of the lighting appliance may be set to greater than 1,000,000 Lm/m².

The light-emitting elements 4 are mounted on the mounting portions 1, and the light-emitting elements 4 and the mounting portions 1 have the same number and are in one-to-one correspondence. When a plurality of mounting portions 1 are disposed, the mounting portions 1 are spaced apart from each other in a horizontal direction and do not overlap with the connecting portion 9 (or the power supply assembly) in a vertical direction. In other words, the overlap area of the mounting portions 1 in the vertical direction is zero. The light-emitting elements 4 are disposed in the mounting portions 1. The light-emitting element 4 is one of main heating components during operation of the lighting device, and the power supply assembly is also one of the heating components during operation of the lighting device. The heating components are spaced apart from each other or do not overlap, which can effectively prevent heat accumulation (or heat concentration) from weakening the light-emitting effect of the lighting device.

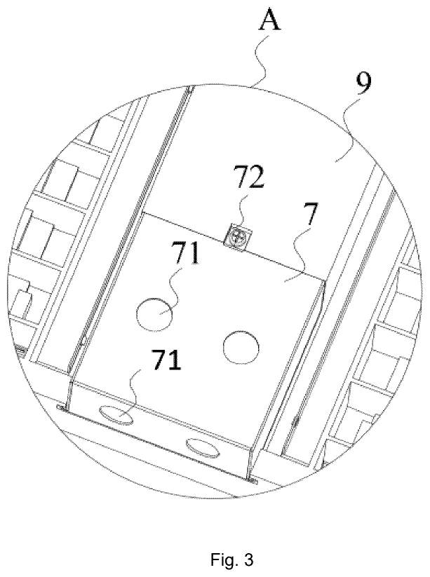

Further referring to FIG. 3, the power supply assembly is mounted on the connecting portion 9 of the housing 100. The power supply assembly needs to be connected to an external device, so the power supply assembly is connected to a plurality of wires. In order to facilitate outgoing of the plurality of wires, the power supply assembly is connected to the junction box 7. The junction box 7 is provided with a chamber capable of accommodating the wires, and at least two surfaces of the junction box 7 are provided with wire outlets 71. The wires located inside the junction box 7 can extend from the wire outlets 71 to the outside. The wire outlets 71 are preferably formed on a top wall and one sidewall of the junction box 7, such that the wires can extend out along a vertical direction through the wire outlet 71 on the top wall of the junction box 7, or along a horizontal direction through the wire outlet 71 on the sidewall of the junction box 7, thereby making it more convenient and flexible for outgoing of the wires.

The junction box 7 is further provided with a connecting lug 72, the connecting lug 72 is disposed on one side of the junction box 7 facing the power supply assembly, and the junction box 7 can be connected to the connecting portion 9 mounted with the power supply assembly by the connecting lug 72. Specifically, the connecting lug 72 may be provided with a through hole, and the connecting portion 9 may be provided with a threaded hole capable of communicating with the through hole of the connecting lug 72. A screw is disposed and sequentially passes through the through hole and the threaded hole, such that the connecting lug is connected to the connecting portion 9 by the screw, and a fixed connection between the connecting lug 72 and the connecting portion 9 is implemented. The disposal of the connecting lug 72 makes it possible to implement the fixation between the junction box 7 and the connecting portion 9 by only one screw, thereby simplifying the steps of connection between the junction box 7 and the connecting portion 9.

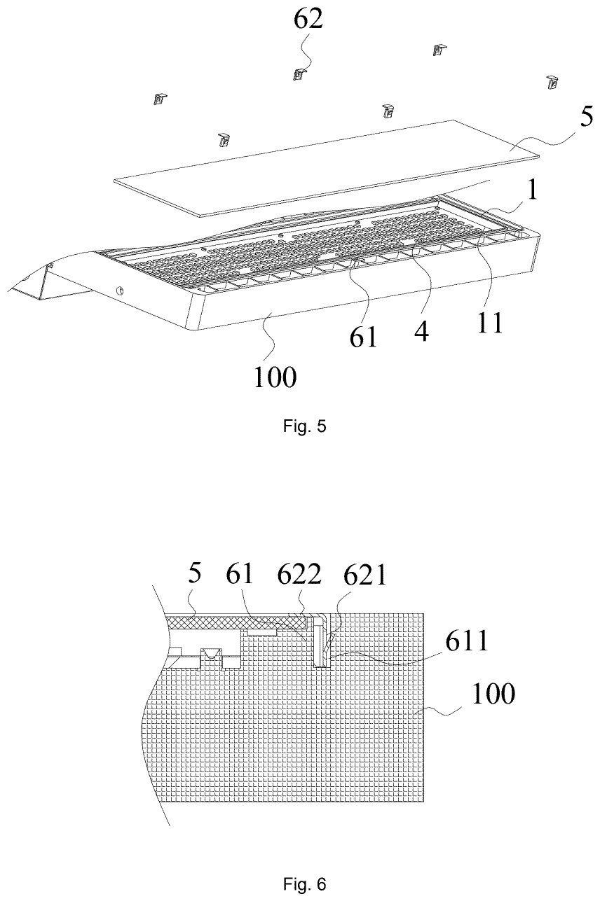

Referring to FIG. 1 and FIG. 5, the light-emitting surface of the lighting device is provided with a lampshade 5. The lampshade 5 completely covers the light-emitting element 4, and the lampshade 5 can process the light emitted by the light-emitting element 4 before emission. The lampshade 5 is connected to the mounting portion 1 of the housing 100. The lampshade 5 and the mounting portion 1 together form an accommodating cavity 11. The light-emitting element 4 is disposed in the accommodating cavity 11, such that the lampshade 5 can cover the light-emitting element 4 connected to the mounting portion 1. In order to enable the light from the light-emitting element 4 to propagate to the outside through the lampshade 5, the lampshade 5 is made of a light-transmitting material, for example, the lampshade 5 is made of transparent plastics, acrylics, textiles, glass, polycarbonate (PC), etc. When the light emitted by the light-emitting element 4 is optically coupled to the lampshade 5, at least one of phenomena of light diffusion, transmission, refraction, diffraction, etc. will occur, that is, the lampshade 5 has at least one of functions of light diffusion, transmission, refraction, diffraction, etc. The lampshade 5 may be of a common rectangular plate-like structure. In some embodiments, in order to adjust the shape of the light emitted by the lighting appliance, the lampshade 5 is adjusted to be in an arc shape or some shapes with specific curved surfaces, such that the light emitted by the light-emitting element 4 undergoes light diffusion, transmission, refraction, diffraction and other phenomena at different positions, thereby obtaining different light shapes. In an embodiment of the present invention, the connection between the lampshade 5 and the mounting portion 1 may be a screw connection. Specifically, the lampshade 5 is provided with a screw hole, and the mounting portion 1 is provided with a threaded hole fitly connected to the screw hole. The lampshade 5 is tightly pressed on the mounting portion 1 by a screw that passes through the screw hole and is in threaded connection with the threaded hole, thereby implementing a fixed connection between the lampshade 5 and the mounting portion 1.

In another embodiment of the present invention, the lampshade 5 and the mounting portion 1 may also be fixedly connected by a plurality of fixing units 6. The lampshade 5 does not need to be provided with the screw hole, such that the accommodating cavity 11 formed by the lampshade 5 and the mounting portion 1 together is a sealed chamber, and water vapor can be prevented from entering the accommodating cavity 11 to cause damage to the light-emitting element 4.

Specifically, one part of the fixing units 6 are connected to the mounting portion 1, and another part of the fixing units are connected to the lampshade 5, so as to connect the lampshade 5 to the mounting portion 1. At least part of the fixing units 6 are distributed on two opposite sides of the lampshade 5, so as to fix the two opposite sides of the lampshade 5.

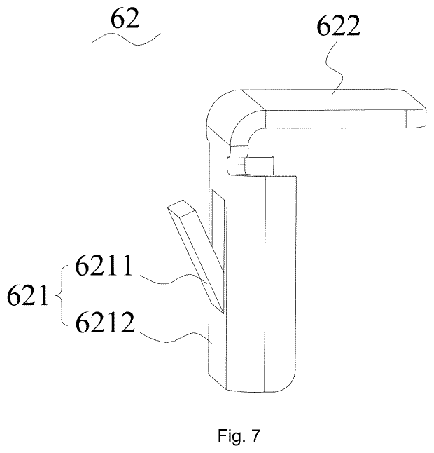

Further referring to FIG. 5 to FIG. 7, the fixing unit 6 may specifically include a fixing portion 61 and a fixing member 62. The fixing portion 61 is connected to the mounting portion 1, and the fixing portion 61 is preferably of an integrated structure with the mounting portion 1 and may be formed together with the housing 100 for the lighting device when the housing 100 for the lighting device is formed by using an integrated die-casting process. The fixing portion 61 is provided with a fixing groove 611 configured to be fitly connected to the fixing member 62.

The fixing member 62 includes a first connecting portion 621 and a second connecting portion 622 connected to each other, where the first connecting portion 621 and the second connecting portion 622 are preferably of an integrated structure, that is, the fixing member 62 is formed by integrally stamping a material, and one end of the fixing member 62 is bent to form the second connecting portion. The first connecting portion 621 is roughly perpendicular to the second connecting portion 622. The first connecting portion 621 is perpendicular to the light-emitting surface of the lighting device and is inserted into the lighting device. The second connecting portion 622 is parallel to the light-emitting surface of the lighting device and is in press fit with the light-emitting surface of the lighting device to fix the lampshade 5. At least a part of the first connecting portion 621 is accommodated in the fixing groove 611, and the first connecting portion 621 is in interference fit with the fixing portion 61 formed with the fixing groove 611, such that the fixing member 62 can be fixed to the fixing portion 61. The first connecting portion 621 may specifically include a first sidewall 6211 and a second sidewall 6212 connected to each other. The first sidewall 6211 is inclined relative to the second sidewall 6212, and the first sidewall 6211 can rotate towards the second sidewall 6212 when pressed and store elastic potential energy. In a release state, a maximum spacing between a side surface of the first sidewall 6211 facing away from the second sidewall 6212 and a side surface of the second sidewall 6212 facing away from the first sidewall 6211 is greater than the width of the fixing groove 611, that is, a maximum distance from a farthest end of the first sidewall 6211 to a surface (the surface refers to a surface of the second sidewall 6212 for fixing the first sidewall 6211) of the second sidewall 6212 is greater than the width of the fixing groove 611. When the fixing member 62 is mounted on the fixing portion 61, the second sidewall 6212 and the first sidewall 6211 abut against a pair of opposite sidewalls of the fixing groove 611, and the first sidewall 6211 is pressed to rotate towards the second sidewall 6212, such that the maximum spacing between the side surface of the first sidewall 6211 facing away from the second sidewall 6212 and the side surface of the second sidewall 6212 facing away from the first sidewall 6211 is equal to the width of the fixing groove 611, that is, the maximum distance from the farthest end of the first sidewall 6211 to the surface (the surface refers to the surface of the second sidewall 6212 for fixing the first sidewall 6211) of the second sidewall 6212 is equal to the width of the fixing groove 611. At this time, the first sidewall 6211 stores elastic potential energy, and the fixing member 62 is in interference fit with the fixing portion 61, such that the fixing member 62 is fixed to the fixing portion 61.

At least a part of the second connecting portion 622 abuts against an outer end surface of the lampshade 5, and a position of the second connecting portion 622 is adjusted by controlling the length of the first connecting portion 621 extending into the fixing groove 611, such that the second connecting portion 622 can tightly press the lampshade 5 against the mounting portion 1, thereby implementing the fixed connection between the lampshade 5 and the mounting portion 1.

In other embodiments of the present invention, the lampshade 5 may also be fixed by means of glue or buckles.

In yet another embodiment of the present invention, a surface of the lampshade 5 is provided with optical structures in a microarray, such as a convex, concave or inclined microstructure array, such that the lampshade has different light-emitting effects.

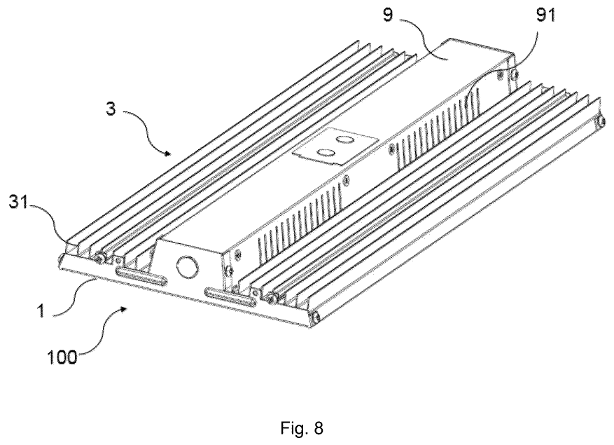

Referring to FIG. 8, which is a schematic front view of an overall structure of a lighting device in another embodiment of the present invention. As shown in FIG. 8, the lighting device includes a housing 100. The housing 100 is roughly rectangular as seen from the top. Along a length direction of a rectangle, a connecting portion 9 extending in a direction parallel to the length direction is disposed. Two sides of the connecting portion 9 along a width direction are provided with mounting portions 1. The mounting portions 1 can be configured to dispose a light-emitting element 4 and a heat dissipation portion 3. The light-emitting element 4 and the heat dissipation portion 3 are disposed on different surfaces of the mounting portions 1. In other words, the light-emitting element 4 and the heat dissipation portion 3 are disposed on opposite surfaces of the mounting portions 1, that is, in a light-emitting direction, the light-emitting element and the heat dissipation portion are stacked. During actual use of the lighting device, the heat dissipation portion 3 is located above the light-emitting element 4, and heat generated by the light-emitting element 4 during operation can be well dissipated to the heat dissipation portion 3. In an embodiment of the present invention, at least one heat dissipation fin 31 is disposed on the heat dissipation portion 3, the heat dissipation fin 31 extends along a length direction of the lighting device, and the lighting device includes a plurality of heat dissipation fins 31, where the heat dissipation fins 31 are arranged at a certain distance from each other. The heat dissipation fin 31 has a flat surface. A strip-shaped gas flow passage extending along the length direction of the lighting device is formed between the two heat dissipation fins 31. Preferably, the surface of the heat dissipation fin 31 is a smooth and flat surface, such that the inside of the gas flow passage formed is smooth and flat, without affecting the gas flow passage.

In an embodiment of the present invention, a plurality of heat dissipation grooves 91 are formed on two sidewalls of the connecting portion 9 facing the heat dissipation portion 3. The heat dissipation grooves 91 penetrate through the sidewalls of the connecting portion 9, such that the inside of the connecting portion 9 communicates with the outside to implement rapid gas exchange (gas flow). In some embodiments, a space in which a power supply assembly (not shown in the figure) can be disposed is provided inside the connecting portion 9. The power supply assembly is also one of main heating components in the lighting device and may also face a heat dissipation problem during actual operation. The sidewalls of the connecting portion 9 are provided with the heat dissipation grooves 91, which can effectively dissipate heat of a power supply, thereby maintaining efficient and stable operation of the lighting device.

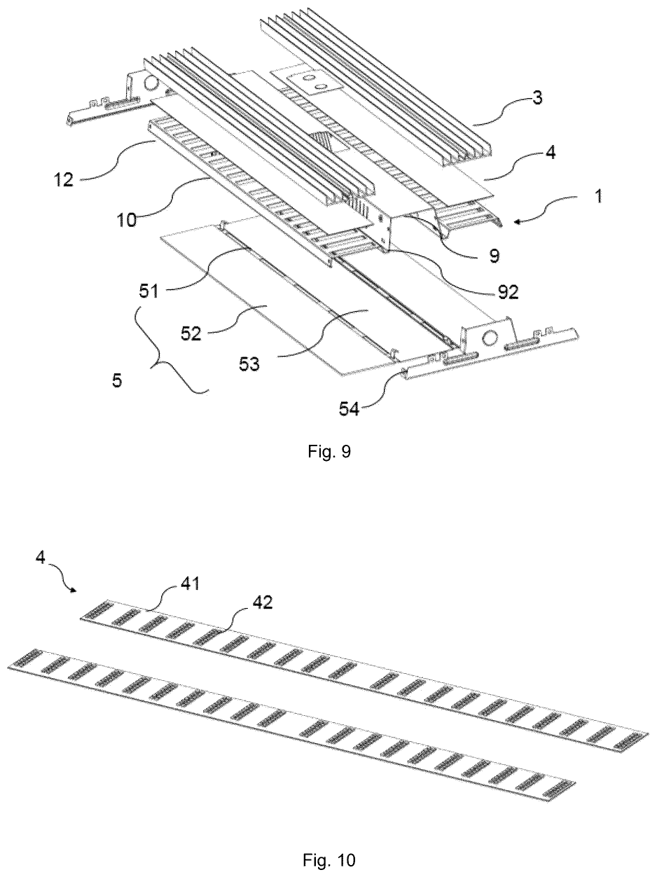

With reference to FIG. 9 which is a schematic exploded view (front) of a lighting device in an embodiment of the present invention, and in conjunction with FIG. 10, a housing 100 includes at least two mounting portions 1 and a connecting portion 9, where the mounting portions 1 are used as a mounting body, the connecting portion 9 is disposed between the two mounting portions 1, the connecting portion 9 protrudes upwards and is internally formed with an internal space in which a power supply assembly can be disposed, the mounting portions 1 include light source mounting portions 10, the two light source mounting portions 10 are disposed on two sides of the connecting portion 9 respectively, a plurality of hollow grooves 12 are formed on each of the light source mounting portions 10, and the hollow grooves 12 are configured to expose a light source and allow light to pass through. A light-emitting element 4 is stacked on a back surface of the light source mounting portion 10, that is, in a light-emitting direction facing away from the housing 100, where the light-emitting element 4 includes a lamp board 41 and a light-emitting body 42 disposed on the lamp board 41, the light-emitting body 42 is disposed on a surface of the lamp board 41 close to the light source mounting portion 10, and light emitted by the light-emitting body 42 can pass through the hollow groove 12.

In an embodiment of the present invention, the light-emitting body 42 is an LED chip array, and a plurality of LED chip arrays are disposed on the lamp board 41, where each LED chip array corresponds to one hollow groove 12, that is, light emitted by the LED chip array can be emitted through the hollow groove 12, and the number of the hollow grooves 12 is greater than or equal to the number of the LED chip arrays. A heat dissipation portion 3 is stacked on a surface of the light-emitting element 4 facing away from the light source mounting portion 10. Heat generated by the light-emitting element 4 during operation is quickly conducted to the outside and dissipated by the heat dissipation portion 3.

A lampshade 5 is disposed in the light-emitting direction of the light source mounting portion 10 (or the mounting portion 1). The lampshade 5 is disposed on the light source mounting portion 10 (or the mounting portion 1) in a covering manner and completely covers the light-emitting body 42, such that the light emitted by the light-emitting body 42 is processed and then finally emitted from the lighting device.

The lampshade 5, the mounting portion 1, the light-emitting element 4, and the heat dissipation portion 3 are sequentially stacked along an opposite direction of the light-emitting direction of the lighting device, and a certain gap is formed between the light-emitting element 4 and the lampshade 5 to form a certain gas space for heat dissipation. End caps 54 are disposed at two ends of each of the lampshade 5, the mounting portion 1, the light-emitting element 4, and the heat dissipation portion 3 along the length direction. The end caps 54 encapsulate the above components and bear or abut against each other in mechanical structure, thereby improving the overall reliability of the lighting device (a fixing structure such as an adhesive structure, a screw fixation structure, a buckling structure, a magnetic structure, or a welding structure may also be provided between the above components).

The light source mounting portion 10 and the connecting portion 9 are connected by a bent portion 92. In another embodiment, the light source mounting portion 10 and the connecting portion 9 are integrally formed on the same board, for example, formed by stamping. The height of the light source mounting portion 10 (or the heat dissipation portion 3) is less than the height of the connecting portion 9, that is, the light source mounting portion 10 (or the heat dissipation portion 3) will not hinder heat dissipation of the connecting portion 9 on two sides of the connecting portion 9. In other words, there is a height difference between the connecting portion 9 and the light source mounting portion 10 (or the heat dissipation portion 3) along the light-emitting direction of the lighting device. The lampshade 5 includes an air vent 51 and at least one light processing element. The light processing element includes a first optical member 52 and a second optical member 53, where the first optical member 52 and the second optical member 53 may be formed integrally or separately, and the first optical member 52 is made of a light-transmitting material and is disposed on one side of the light source mounting portion 10 along the light-emitting direction of the lighting device in a covering manner. The second optical member 53 is disposed on one side of the connecting portion 9 along the light-emitting direction of the lighting device in a covering manner, where the second optical member 53 may be made of a light-transmitting material or a lightproof material. The first optical member 52 and the second optical member 53 may be made of one or more of materials such as plastic, resin, and glass.

A plurality of air vents 51 are formed along a length direction of the first optical member and a length direction of the second optical member between the first optical member 52 and the second optical member 53. The air vents correspond to the bent portions 92 in position, and corresponding air vents (not shown in the figure) may also be formed on the bent portions 92, such that the lighting device also has a through air flow channel along the light-emitting direction, and an airflow can directly convect from a light-emitting surface of the lighting device to a back side of the lighting device, that is, the other side facing away from the light-emitting direction, and spread into the outside environment, thereby quickly taking away heat generated by the lighting device during operation.

In an embodiment of the present invention, the first optical members 52 are disposed on two sides of the second optical member 53, or the first optical member 52 is disposed on an outer side of the second optical member 53, that is, the first optical member 52 is disposed below the light source mounting portion 10 (i.e., along the light-emitting direction of the lighting device, “below” refers to being away from the light-emitting direction), the second optical member 53 is disposed below the connecting portion 9, and the first optical member 52 and the second optical member 53 are integrally formed.

Referring to FIG. 10, which is a schematic diagram of a light-emitting element 4 in an embodiment of the present invention. The light-emitting element 4 includes a lamp board 41 and a plurality of light-emitting bodies 42 disposed on the lamp board 41, where a circuit structure is disposed on the lamp board 41 and can conduct the light-emitting bodies 42. The light-emitting bodies 42 emit light by supplying power to the lighting device. The light-emitting bodies 42 may be LED chip arrays (or LED bead arrays), which are disposed at equal or non-equal intervals.

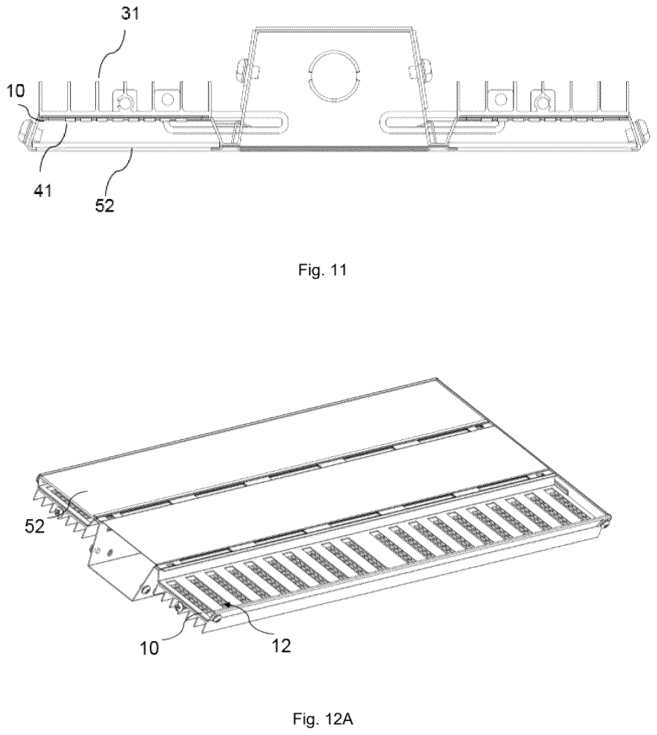

Referring to FIG. 9, FIG. 10, FIG. 11, FIG. 12A, and FIG. 12B together. FIG. 11 is a sectional view of a lighting device along a width direction in an embodiment of the present invention. FIG. 12A is a schematic diagram of a lighting device after removing some components on a back surface of the lighting device. FIG. 12B is a schematic diagram of mounting positions of a light source mounting portion, a light-emitting element, and a heat dissipation portion in an embodiment. As shown in FIG. 9, FIG. 11, and FIG. 12B, the light-emitting element 4 is stacked on the light source mounting portion 10, the surface of the light source mounting portion 10 provided with the light-emitting element 4 may be a flat surface or a groove-like surface with low middle and two high sides, and when the surface is the groove-like surface, at least part of the light-emitting element 4 is accommodated in a groove of the groove-like surface, and at least part of the heat dissipation portion 3 is accommodated in a groove structure of the groove-like surface. In an embodiment, a surface (or a surface along the light-emitting direction) of the lamp board 41 in the light-emitting element 4 that faces the lampshade 5 is attached to the surface of the light source mounting portion 10, and a surface of the lamp board 41 facing away from the light-emitting direction is attached to a surface of the heat dissipation portion 3. In other words, the lamp board 41 has a first surface and a second surface which are opposite to each other, where the first surface is provided with a plurality of light-emitting bodies 42, the light source mounting portion 10 is attached to the first surface, and the heat dissipation portion 3 is attached to the second surface. The light source mounting portion 10 and the heat dissipation portion 3 may be made of a metal material with fast heat conduction and heat dissipation, in order to quickly conduct and dissipate the heat generated by the light-emitting element 4 during operation.

In an embodiment of the present invention, the lamp board 41 and the first optical member 52 are spaced at a certain distance from each other, and a cavity is formed along a length direction of the lamp board and a length direction of the first optical member between the lamp board and the first optical member for heat dissipation; the lamp board 41 and the surface of the heat dissipation portion 3 may also be spaced at a certain distance from each other to form a cavity for heat dissipation; and air flows through the cavity.

In conjunction with FIG. 12A, a plurality of hollow grooves 12 are provided along the light source mounting portion 10, the hollow grooves 12 are formed along a width direction of the light source mounting portion 10 and are parallel to the light source mounting portion, the light-emitting bodies 42 correspond to the hollow grooves in position 12 and are exposed through the hollow grooves 12, and the light emitted by the light-emitting bodies 42 can be directly emitted to the first optical member 52 through the hollow grooves 12. Certainly, in some embodiments, the hollow grooves 12 may also not be parallel to each other, that is, there is an angle between the hollow grooves 12.

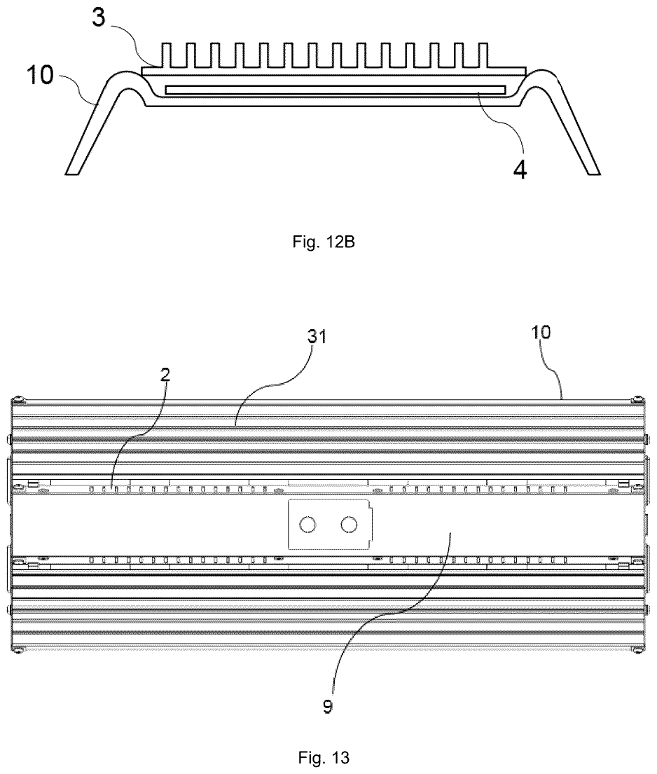

Referring to FIG. 13, which is a top view of a lighting device in an embodiment of the present invention, a longitudinally-through heat dissipation channel 2 is further provided between the connecting portion 9 and the light source mounting portion 10. The heat dissipation channel 2 is formed on the bent portion 92 and is longitudinally through in combination with the air vents 51, that is, the heat dissipation channel 2 is roughly perpendicular to the lampshade 5, or the heat dissipation channel 2 extends along or away from the light-emitting direction of the lighting device to penetrate through the lighting device, such that gas on the light-emitting surface of the lighting device can directly exchange with gas on the back side (one side facing away from the light-emitting surface) of the lighting device through the heat dissipation channel 2.

In an embodiment of the present invention, the connecting portion 9 has two surfaces approximately perpendicular to the lampshade 5, or the sidewalls of the connecting portion 9, and heat dissipation grooves 91 may be further formed on the sidewalls of the connecting portion 9.

In an embodiment of the present invention, the light source mounting portion 10 in the mounting portion 1 is rotatable relative to the connecting portion 9, that is, a light-emitting angle of the lighting device can be changed with the rotation of the light source mounting portion. In other words, the light-emitting angle of the lighting device can be adjusted as needed.

Referring to FIG. 14, which is a schematic overall view of a lighting device in yet another embodiment of the present invention, the lighting device includes a connecting portion 9 and light source mounting portions 10 movably connected to two sides of the connecting portion 9, where a heat dissipation portion 3 is disposed on the light source mounting portion 10, the heat dissipation portion 3 includes a plurality of heat dissipation fins 31 (not shown in the figure) extending along a length direction of the lighting device, a maximum surface (a heat dissipation surface) of the heat dissipation fin 31 is roughly perpendicular to a light-emitting surface (the light-emitting surface may be a horizontal plane in a light-emitting direction of the lighting appliance, or may be a lampshade 5 in the present invention) of the lighting device, and heat dissipation surfaces of the heat dissipation fins 31 are parallel to each other and form an air flow channel along the length direction of the lighting device, that is, roughly parallel to the lampshade 5. A plurality of open ventilation windows 13 are formed on sidewalls of the light source mounting portion 10. The open ventilation windows 13 enable gas flow along a width direction of the lighting device. That is, part of gas in the air flow channel of the heat dissipation portion 3 is exchanged with gas outside the lighting device through the open ventilation windows 13.

A plurality of heat dissipation grooves 91 are formed on the sidewalls of the connecting portion 9, such that the inside of the connecting portion 9 communicates with the outside environment to implement gas exchange. In this embodiment, the lighting device further includes end caps 54, where the end cap includes a first end cap 540 and a second end cap 541, the first end caps 540 are fixed to two ends of the connecting portion 9, the second end caps 541 are fixed to two ends of the light source mounting portion 10, the first end cap 540 includes a rotary connecting area 5400 configured to be connected to and fixed to the second end cap 541, the second end cap 541 is fastened at an end part of the light source mounting portion 10, the first end cap 540 covers a side surface of the second end cap 541 away from the light source mounting portion 10, and the first end cap 540 covers at least a part of the second end cap 541. The first end cap 540 is connected to the second end cap 541 by a bolt, a rivet, or another rotatable fixing structure.

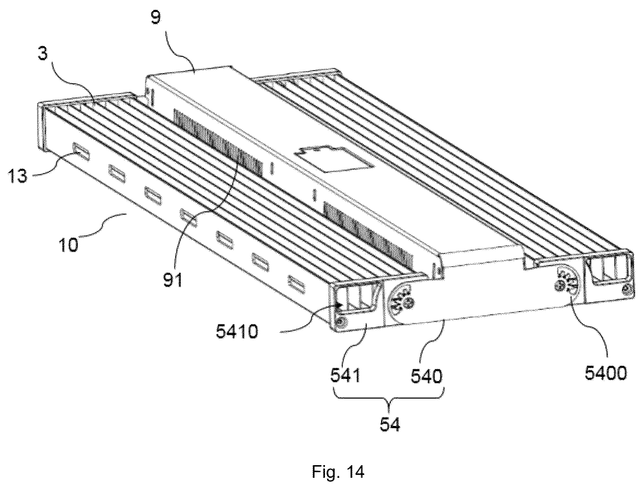

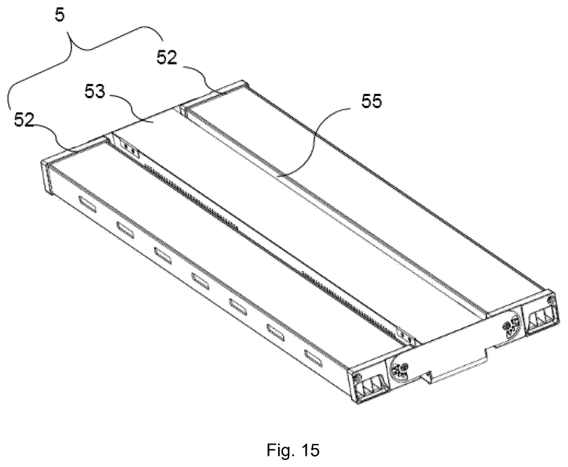

Referring to FIG. 15, which is a schematic diagram of the lampshade in this embodiment of the present invention, the lampshade 5 includes a first optical member 52 and a second optical member 53, where the first optical member 52 and the second optical member 53 are independent of each other and spaced at a certain distance. The first optical member 52 is fixed to the light source mounting portion 10, and the second optical member 53 is fixed to the connecting portion 9. There is a gap 55 between the light source mounting portion 10 and the connecting portion 9. The gap 55 can provide the heat dissipation channel. That is, the heat dissipation channel 2 is formed between the mounting portion 1 (or the light source mounting portion 10) and the connecting portion 9. In addition, the width of the gap 55 is greater than or equal to (√2-1)/2 the thickness of the light source mounting portion 10, thereby preventing the light source mounting portion 10 from interfering with the connecting portion 9 during rotation. The light source mounting portion 10 is rotatable relative to the connecting portion 9, that is, the first optical member 52 and the second optical member 53 are rotatable relative to each other. Relative positions and angles of the first optical member and the second optical member may be in various forms. For example, the relative angle between the first optical member 52 and the second optical member 53 may be −120° to 180°, such as 30°, 60°, and 90°, and the first optical member 52 and the second optical member 53 are independently formed and spaced at a certain distance.

In some embodiments, the sidewalls of the connecting portion 9 may also be in an inwards shrunk arc shape, such as an inwards recessed arc shape, such that the width of the gap 55 can be reduced or even the gap 55 can be canceled.

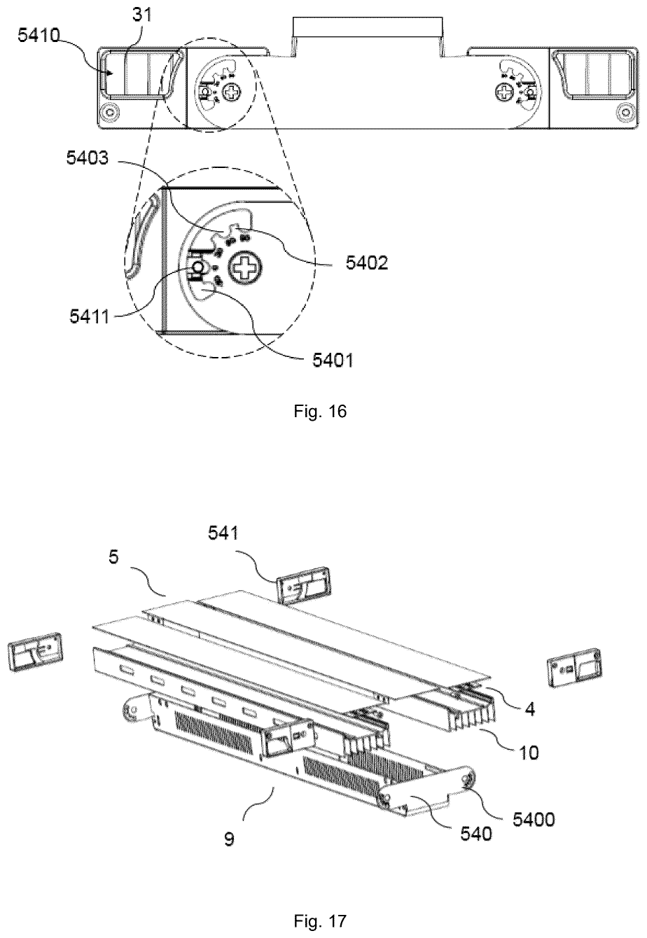

Referring to FIG. 16, which is a view of a lighting device along a length direction in an embodiment of the present invention. As shown in the figure, an end cap open window 5410 directly faces the air flow channel formed by the heat dissipation fins 31 of the heat dissipation portion 3. The gas can be quickly exchanged inside and outside the lighting appliance through the air flow channel, thereby quickly taking away the heat generated by the lighting device during operation (which may also be the heat generated by the light source or the light-emitting element of the lighting device). Referring to the partial enlarged view of the rotary connecting area 5400 in FIG. 16, an arc-shaped open window 5401 is further formed on the first end cap 540, an edge of the arc-shaped open window 5401 is provided with limiting teeth 5402 and limiting grooves 5403, the limiting teeth 5402 and the limiting grooves 5403 are spaced apart from each other and arranged along an arc-shaped long edge of the arc-shaped open window 5401, the edge of the arc-shaped open window 5401 is further provided with angle indexes, and an angle of the light source mounting portion 10 can be accurately adjusted according to the angle indexes. A limiting pillar 5411 is disposed on the second end cap 541. The limiting pillar is slidable relative to the second end cap 541. That is, the limiting pillar 5411 may be clamped into the limiting groove 5403 by pulling or separated from the limiting groove 5403 by pulling. When the limiting pillar 5411 is separated from the limiting groove 5403, the light source mounting portion 10 is capable of rotating relative to the connecting portion 9 to adjust the light-emitting angle of the lighting device. When the limiting pillar 5411 is clamped into the limiting groove 5403, the light source mounting portion 10 is fixed relative to the connecting portion, and the limiting tooth 5402 protrudes outwards to prevent the limiting pillar 5411 from sliding out of the limiting groove 5403.

In this embodiment of the present invention, two rotary connecting areas 5400 are disposed on each first end cap 540, that is, two arc-shaped open windows 5401 are provided, and at least one limiting pillar 5411 is disposed on each second end cap.

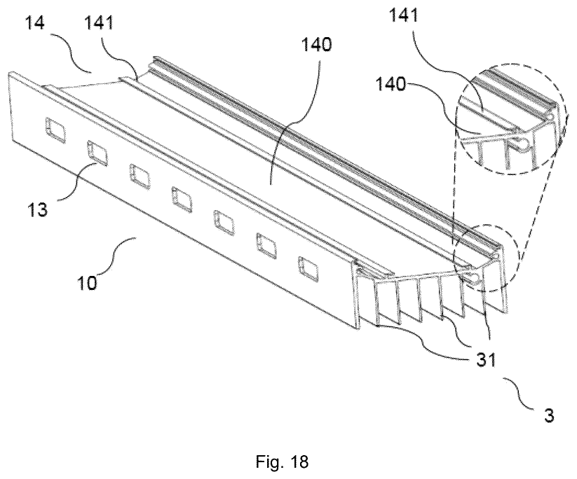

Referring to FIG. 17 and FIG. 18. FIG. 17 is a schematic back exploded view of the lighting device in this embodiment of the present invention. FIG. 18 is a schematic diagram of the light source mounting portion 10 in this embodiment of the present invention. As shown in the figures, the lighting device includes two first end caps 540, where the first end caps 540 are disposed at two ends of the connecting portion 9 along the length direction respectively (the first end caps and the connecting portion 9 may be separately formed, certainly, the first end caps 540 and the connecting portion 9 may also be integrally formed), and the first end caps 540 extend a certain distance to two sides along the width direction to form a rotary connecting area 5400. The lighting device further includes a light source mounting portion 10, where a heat dissipation portion 3 is further disposed on the light source mounting portion 10. The heat dissipation portion 3 may be separately formed with the light source mounting portion 10 before assembly, or integrally formed with the light source mounting portion 10. In this embodiment of the present invention, the heat dissipation portion 3 is integrally formed on the light source mounting portion 10. One side of the light source mounting portion 10 is provided with a heat dissipation portion 3, and the other side thereof opposite to the heat dissipation portion 3 is provided with a light-emitting element 4. The heat dissipation portion 3 and the light-emitting element 4 are stacked along the light-emitting direction. In this embodiment of the present invention, the light-emitting element 4 is connected to the light source mounting portion 10 by means of clamping.

In this embodiment, the light source mounting portion 10 is integrally formed with the heat dissipation portion 3, the light source mounting portion 10 has two opposite surfaces, a plurality of integrally formed heat dissipation fins 31 are disposed on one surface of the light source mounting portion 10, and the plurality of heat dissipation fins 31 form the heat dissipation portion 3. The other surface of the light source mounting portion 10 is a mounting surface. The light source mounting portion includes a mounting bottom surface 140 and a mounting groove 14 formed by protrusions on two sides of the mounting bottom surface 140 and the mounting bottom surface 140, where a plurality of mounting tracks 141 extending along the length direction of the lighting device are disposed on the mounting bottom surface 140 and the protrusions on the two sides, the mounting track 141 has a bent portion, and the bent portion and the mounting bottom surface 140 form a clamping space for clamping the light-emitting element 4.

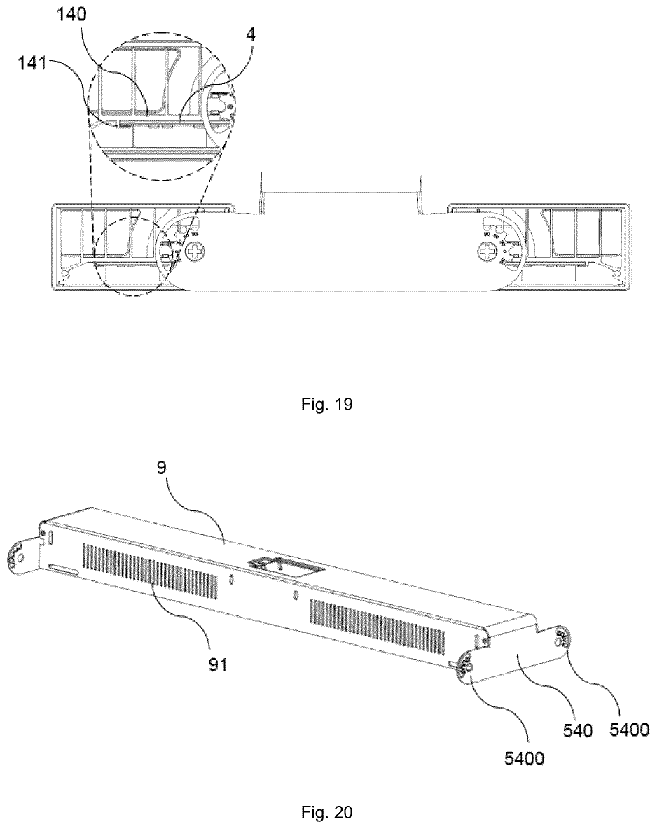

Referring to FIG. 19, which is a schematic diagram of the lighting device after removal of the second end caps in this embodiment of the present invention, and also referring to FIG. 10, FIG. 17, and FIG. 18. As shown in FIG. 19 and its schematic partial enlarged view, the light-emitting element 4 is inserted from one end of the light source mounting portion 10, that is, the lamp board 41 of the light-emitting element 4 is clamped into the clamping space formed by the mounting track 141 and the bottom surface 140 to fix the light-emitting element 4. The light-emitting element 4 can be completely fixed in the light source mounting portion 10 by the mounting track 141.

In some embodiments of the present invention, there are at least two mounting tracks 141, and the mounting tracks 141 are symmetrically disposed along two sides of the mounting bottom surface 140. There may be various distances between every two opposite mounting tracks 141, that is, the mounting tracks 141 can adapt to different sizes of light-emitting elements 4.

In some embodiments of the present invention, the surface of the mounting groove 14 has a light reflection function and can reflect at least part of the light emitted by the light-emitting element 4.

In the present invention, the light source mounting portion 10, the heat dissipation portion 3, and the connecting portion 9 may be made of a metal material.

FIG. 20 is a separate schematic diagram of the connecting portion 9 in this embodiment of the present invention. As shown in the figure, the first end caps 540 are integrally formed with two ends of the connecting portion 9 along the length direction, and the first end caps 540 extend a certain distance to two sides along the width direction of the connecting portion to form a rotary connecting area 5400. A tail end of the rotary connecting area 5400 is arc-shaped or semi-circular.

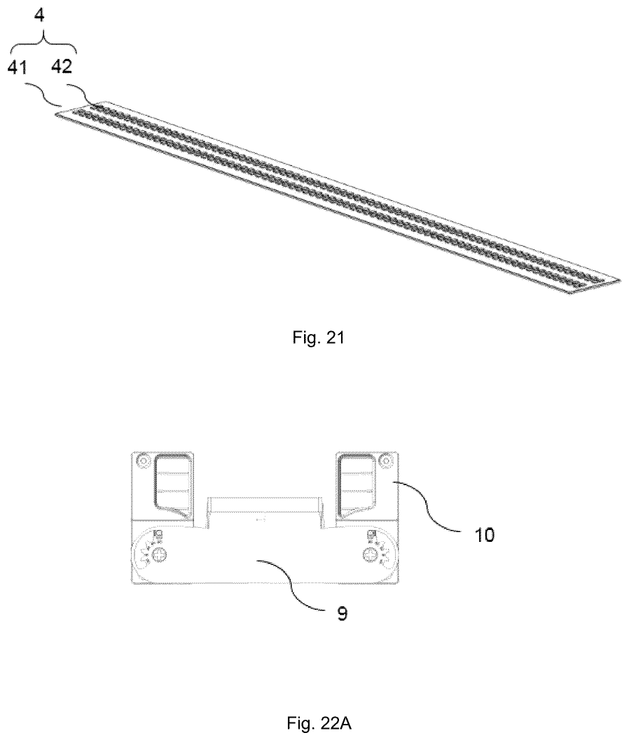

As shown in FIG. 21, which is a schematic diagram of a light-emitting element 4 in an embodiment of the present invention, the light-emitting element includes a lamp board 41 and light-emitting bodies 42 disposed on the lamp board, where the light-emitting bodies 42 may be LED chips or LED beads arranged at equal intervals along a length direction of the lamp board 41. A spacing between the light-emitting bodies 42 may also be set as needed, and an arrangement of the light-emitting bodies 42 may also be adjusted as needed. For example, there are at least two spacings between the light-emitting bodies 42, and the light-emitting bodies 42 are arranged in an arc shape along the length direction of the lamp board 41. FIG. 10 and FIG. 21 are merely illustrative of distance and are not limiting.

In some embodiments of the present invention, the light processing element (the first optical member 52 and the second optical member 53) in the lampshade 5 may be a plane or an optical surface with an arc-shaped structure.

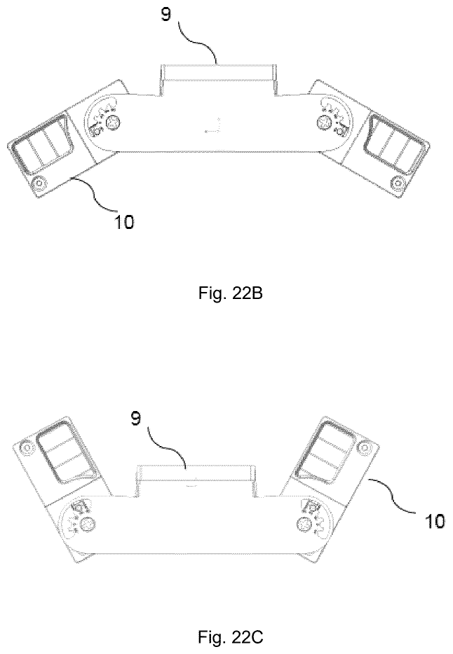

Referring to FIG. 22A, FIG. 22B, and FIG. 22C, which are schematic diagrams of the light source mounting portion 10 and the connecting portion 9 at different angles in this embodiment of the present invention. FIG. 22A shows a shape at an angle of 90°. Under the shape, the lighting device occupies a small space during packaging and transportation, and is convenient to stack and transport. FIG. 22B shows a shape at an angle of −30°. Under the shape, the light emitted by the light source mounting portion 10 is concentrated, thereby being applicable to usage scenarios requiring high brightness and small areas. FIG. 22C is a schematic diagram of a shape at an angle of 60°. The light emitted by the light source mounting portion 10 is divergent, thereby being applicable to wide areas with low illumination. The shape as shown in FIG. 14 is applicable to general usage scenarios, such as warehouses or corridors. Certainly, the above angles are just examples, and the angle can be adjusted according to actual requirements.

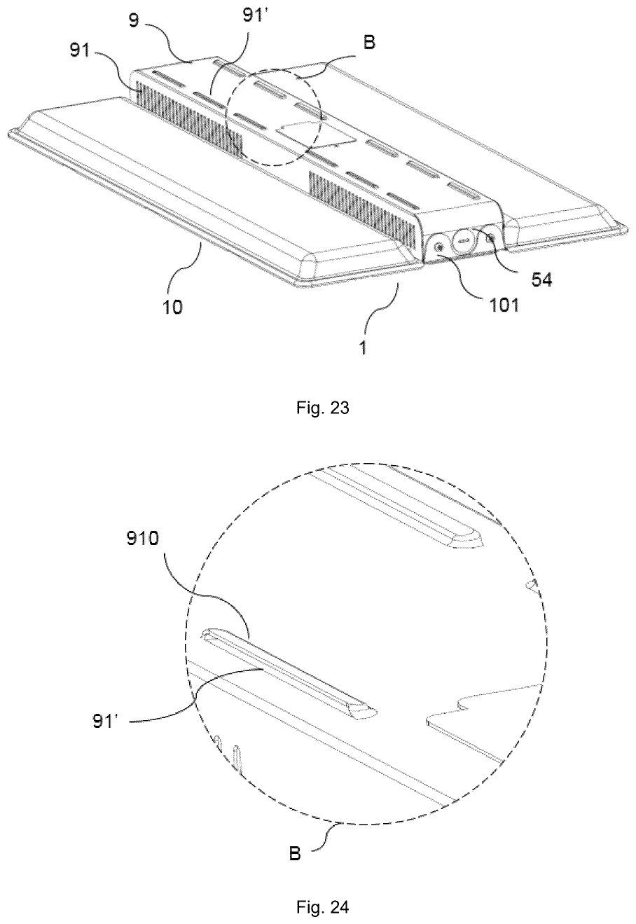

Referring to FIG. 23, which is a schematic diagram of a lighting device in yet another embodiment of the present invention. As shown in the figure, the lighting device includes two mounting portions 1 and a connecting portion 9 fixed between the two mounting portions 1, where the connecting portion 9 is disposed along a length direction of the mounting portions 1. The connecting portion 9 is completely or at least partially supported by the mounting portions 1. The connecting portion 9 is fixed to the mounting portions 1 by positioning plates 101 in conjunction with screws. The positioning plates 101 are located at two ends of the mounting portion 1 along the length direction. The two ends of the connecting portion 9 along the length direction are provided with end caps 54 integrally formed with the connecting portion 9, and it may also be referred to as end parts or end surfaces of the connecting portion 9, that is, the end parts of the connecting portion 9 are connected and fixed to the mounting portions 1 by the positioning plates 101. A plurality of heat dissipation grooves 91 and heat dissipation grooves 91′ are formed on sidewalls and a top surface (the top surface refers to a surface away from the mounting portions 1) of the connecting portion 9, where the heat dissipation grooves 91′ are formed on the top surface of the connecting portion 9, and each further includes a dustproof eave disposed above the heat dissipation groove 91′ in a covering manner and maintaining a certain spacing from the heat dissipation groove 91′. That is, the dustproof eave is disposed above the heat dissipation groove 91′ in a covering manner and does not seal the heat dissipation groove 91′. While the heat dissipation requirements are met, foreign objects can be kept out and prevented from falling into the connecting portion 9 to affect operation of the lighting device.

Referring to FIG. 24, which is a schematic enlarged view of a part B in FIG. 23. As shown in the figure, the dustproof eave 910 is disposed on each heat dissipation groove 91′ in a covering manner. The dustproof eave 910 has a certain radian and is arched in a direction away from the heat dissipation groove 91′ to form an opening structure facing one side. That is, an opening faces an outer side of the connecting portion 9, such that when hot air inside the connecting portion 9 flows out, heat dissipation of the connecting portion 9 will not be affected by airflow counter-collision and heat accumulation due to the fact that two openings are opposite to each other. The dustproof eaves 910 may be integrally formed on the connecting portion 9 by means of a stamping process, or separately formed and then fixed to the connecting portion 9 by means of, for example, glue or welding.

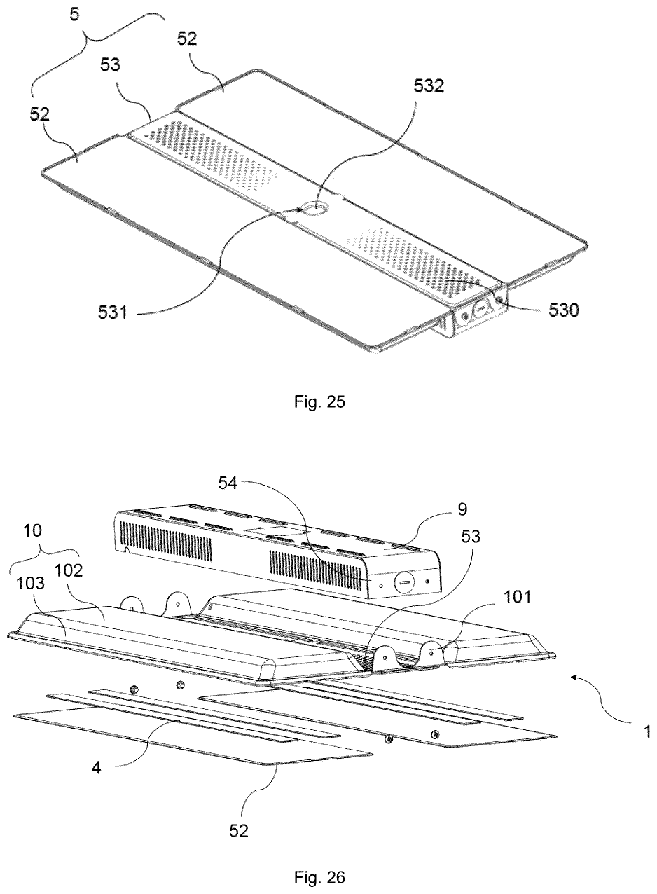

Referring to FIG. 25, which is a schematic back view of a lighting device in an embodiment of the present invention. As shown in the figure, a mounting portion 1 is combined with a lampshade 5, that is, the mounting portion 1 is encapsulated along one side of a light-emitting direction of the lighting device by the lampshade 5. The lampshade 5 includes a first optical member 52 and a second optical member 53. In some embodiments, the first optical member 52 and the second optical member 53 may be integrally formed from the same or different materials, or separately formed from the same or different materials. In some embodiments, a surface of the second optical member 53 is provided with a plurality of heat dissipation holes 530 arranged in an entire column. The heat dissipation holes 530 may have various diameters, or the surface of the second optical member 53 is provided with heat dissipation holes 530 having at least two or more diameters. In an embodiment, the heat dissipation holes 530 on the surface of the second optical member 53 may have the same diameter. In an embodiment, a sensor accommodating hole 531 is further formed on the second optical member 53 and is internally provided with a sensor 532. The sensor 532 is at least partially disposed in the sensor accommodating hole 531. The sensor 532 can sense the outside environment or the inside environment of the lighting device, such as the light intensity, the temperature, the humidity, and other information, and feeds back the environmental information to the lighting device, and correspondingly control the light-emitting effect of the lighting device, such as the light intensity, the color temperature, etc. of the lighting device.

Referring to FIG. 26, which is a schematic exploded view of a lighting device in an embodiment of the present invention. As shown in the figure, a mounting portion 1 is integrally formed and can be formed by integrally stamping, impressing, stretching, extruding, or bending a metal material. The mounting portion 1 includes a second optical member 53 located in the middle. Two positioning plates 101 are disposed at two ends of the second optical member 53 along a length direction respectively. The positioning plates 101 extend to one side of a connecting portion 9 from the second optical member 53, and through holes paired with each other are formed on the positioning plates 101 and end caps 54 and are used for screw structures to pass through and fix the positioning plates 101 and the end caps 54. That is, the connecting portion 9 is directly stacked on the second optical member 53. When a heating element (such as a power supply) is disposed in the connecting portion 9, heat dissipation holes 530 on the second optical member 53 can enable outside air with a low temperature to directly enter the connecting portion 9. When the lighting device is in normal use (i.e. a light-emitting direction faces downward), both heat dissipation grooves 91′ and heat dissipation grooves 91 on the connecting portion 9 are higher than the heat dissipation holes 530 (see FIG. 25), and air with a high temperature will rise, that is, air in the connecting portion 9 rises after being heated, such that after the air flows out of the heat dissipation grooves 91′ and the heat dissipation grooves 91, convection will be formed for the outside air through the heat dissipation holes 530, and a similar air suction effect is formed, that is, directional air flow is formed, thereby improving the heat dissipation performance.

Light source mounting portions 10 are disposed on two sides of the second optical member 53 along the length direction respectively, that is, the second optical member 53 is clamped by the light source mounting portions 10 located on the two sides. It is worth noting that the second optical member 53 and the light source mounting portions 10 located on the two sides are integrally formed from a metal material, have good heat dissipation performance for each other, and can quickly conduct and dissipate heat generated by the lighting device during operation. The light source mounting portion 10 includes a flat light source mounting portion bottom plate 102 and a light source mounting portion sidewall 103 disposed around the light source mounting portion bottom plate 102, where the light source mounting portion bottom plate 102 and the light source mounting portion sidewall 103 form a groove-like accommodating space, and at least part or all of light-emitting elements 4 are disposed in the accommodating space. In this embodiment of the present invention, at least two light-emitting elements 4 are disposed along a length direction in each light source mounting portion 10. One end of the light source mounting portion sidewall 103 far away from the light source mounting portion bottom plate 102 is folded towards an outer side of a groove to form a mounting eave parallel to the light source mounting portion bottom plate 102 for fixing the second optical member 53. The mounting eave and the second optical member can be fixed to each other by means of adhesives or buckles.

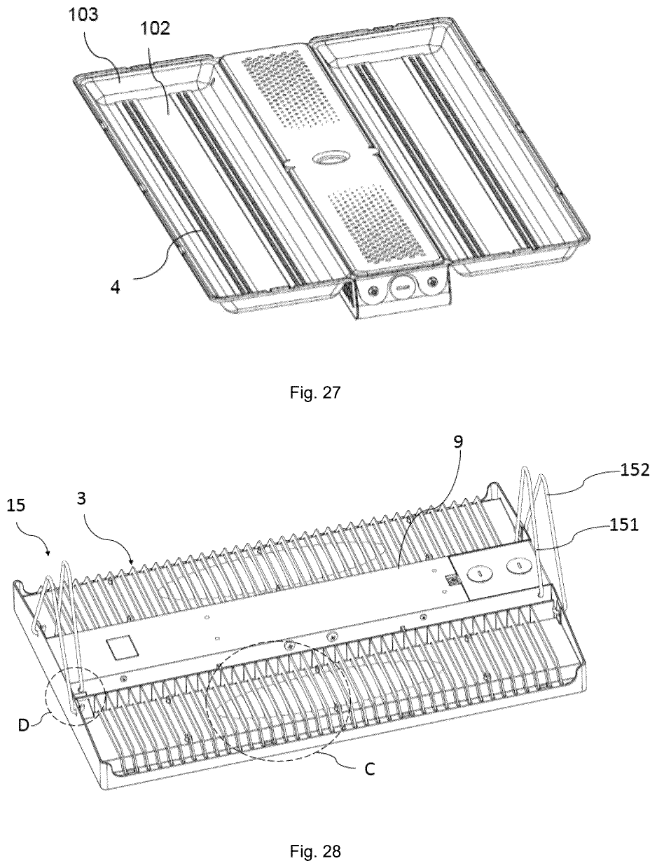

Referring to FIG. 27, which is a schematic back view of a lighting device after removal of a second optical member in an embodiment of the present invention. As shown in the figure, light-emitting elements 4 are attached to a light source mounting portion bottom plate 102, and the light-emitting elements are disposed along a length direction of a light source mounting portion 10 and occupy at least 60% or above of the length of the light source mounting portion 10. In this embodiment of the present invention, two light-emitting elements 4 parallel to each other and spaced at a certain distance are attached to the light source mounting portion bottom plate 102 of each light source mounting portion 10. In an embodiment, the light-emitting elements 4 is disposed by means of buckles or welding.

The light-emitting elements 4 may also be staggered from each other, or at least partially disposed on the light source mounting portion bottom plate 102 and at least partially disposed on a light source mounting portion sidewall 103.

In the present invention, a lampshade 5, a first optical member 52, or a second optical member 53 has at least one or more functions of light transmission, refraction, reflection, or diffraction.

In some embodiments of the present invention, the lighting device further includes hanging support structures. As shown in FIG. 28, the hanging support structures are disposed at two ends of the lighting device along a length direction. The hanging support structure may be an arc-shaped bent structure, and there is at least one hanging support structure. In an embodiment, the hanging support structures are disposed at two ends of the lighting appliance along a width direction. The hanging support structures are connected to the lighting device by through holes formed at two ends of the lighting device, and the hanging support structures are rotatable relative to the lighting device. For ease of description, the hanging support structures are named hanging support members 15. As shown in FIG. 28, the hanging support members 15 are disposed at two ends of the lighting device along the length direction. In this embodiment of the present invention, the hanging support member 15 includes at least one first hanging support member 151 and at least one second hanging support member 152. The first hanging support member 151 and the second hanging support member 152 may be formed by bending metal rods or metal strips, or may be formed from other materials such as plastics. The first hanging support member 151 and the second hanging support member 152 may be of an integrated strip-like or rod-like structure, or a multi-segment chain structure, where the first hanging support member 151 and the second hanging support member 152 include at least one arc-shaped structure pointing in a direction of the lighting device and at least one arc-shaped structure pointing in a direction away from the lighting device respectively.

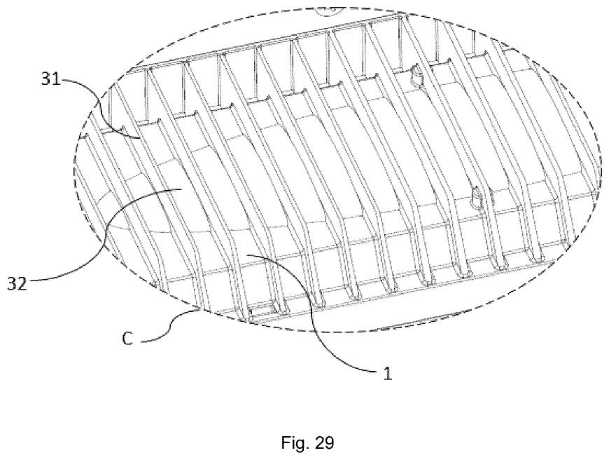

Referring to FIG. 29, which is a partial enlarged view of a part C in FIG. 28. As shown in the figure, the heat dissipation portion 3 disposed on the mounting portion 1 includes a plurality of heat dissipation fins 31 parallel to each other and perpendicular to the light-emitting surface of the lighting device. In an embodiment, the heat dissipation fins 31 are integrally formed on one side of the mounting portion 1 away from the light-emitting direction of the lighting device, and at least partially contact with the connecting portion 9, which can effectively conduct the heat generated by the lighting device during operation to the outside environment so as to implement efficient heat dissipation.

In an embodiment, the mounting portion 1 can be further provided with a raised heat dissipation arc surface 32 away from the light-emitting surface of the lighting device. The heat dissipation arc surface 32 can increase the contact area between gas inside the lighting device and the mounting portion 1 and/or the heat dissipation fins 31 (or the heat dissipation portion 3), and the contact area between gas outside the lighting device and the mounting portion 1 and/or the heat dissipation fins 31, thereby improving the heat exchange/conduction efficiency of the gas inside and outside the lighting device and the mounting portion 1 and/or the heat dissipation fins 31, and enhancing the overall heat dissipation capability of the lighting device. Among them, there are one or more heat dissipation arc surfaces 32, which can be integrally formed on the mounting portion 1 by means of stamping or die casting.

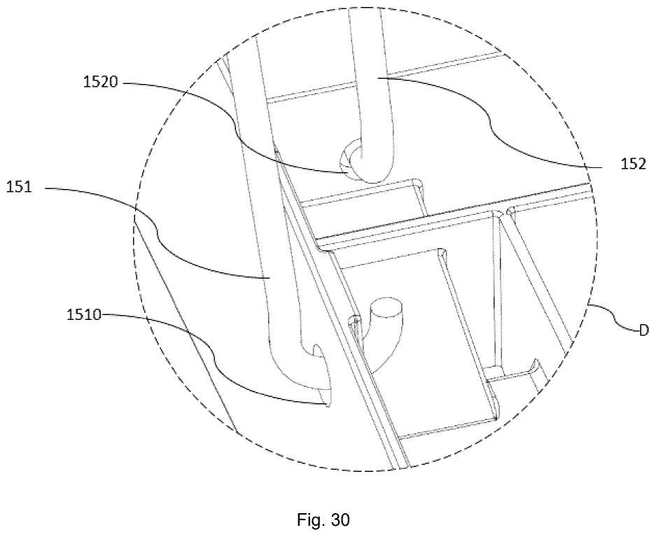

Referring to FIG. 30, which is a partial enlarged view of a part D in FIG. 28. As shown in the figure, a first hanging support hole 1510 corresponding to the first hanging support member 151 is formed on the housing 100 for the lighting device, a second hanging support hole 1520 corresponding to the second hanging support member 152 is formed on the sidewall of the connecting portion 9, and tail ends of the first hanging support member 151 and the second hanging support member 152 are provided with bent portions opposite to a direction of gravity. The bent portions pass through the first hanging support hole 1510/the second hanging support hole 1520, such that the lighting device will not separate from the hanging support member 15 in a mounting state.

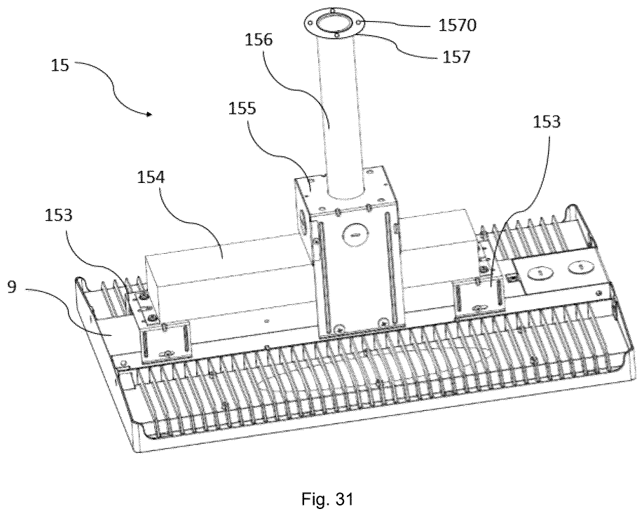

Referring to FIG. 31, which is a hanging support member 15 in another embodiment of the present invention. As shown in the figure, the hanging support member 15 includes first connecting frames 153 directly fixed to the connecting portion 9. There are two first connecting frames 153, which are in a U-shaped structure and are fixed to two sidewalls of the connecting portion 9 by means of screws, rivets, fastening, or welding. The hanging support member further includes a mounting surface basically parallel to the top surface of the connecting portion 9. At least part of a second connecting frame 154 is overlapped with the mounting surface. In other words, the second connecting frame 154 is erected between the two first connecting frames 153. The second connecting frame 154 is roughly parallel to the connecting portion 9, and the second connecting frame 154 is fixed to the first connecting frames 153 by means of screws, rivets, fastening, or welding.

The hanging support member 15 further includes a third connecting frame 155, where the third connecting frame 155 is roughly perpendicular to the connecting portion 9 and is partially stacked on the second connecting portion and partially fixed to the sidewall of the connecting portion 9, and a plurality of mounting holes are formed on the sidewall of the connecting portion 9. A mounting position of the third connecting frame 155 can be adjusted along a length direction of the second connecting frame 154 or the connecting portion 9 as needed. A connecting rod 156 is further disposed on a top surface of the third connecting frame 155 parallel to the connecting portion 9, a tail end of the connecting rod 156 is further provided with a locking disc 157, and a plurality of locking holes 1570 are formed on the locking disc 157. The locking disc 157 can be fixed to a mounting environment (such as a ceiling and a cross beam) by enabling bolts to pass through the locking holes 1570, thereby fixing the lighting device.

In some embodiments, the connecting rod 156 is set to have a telescopic function, and its length can be adjusted as needed.

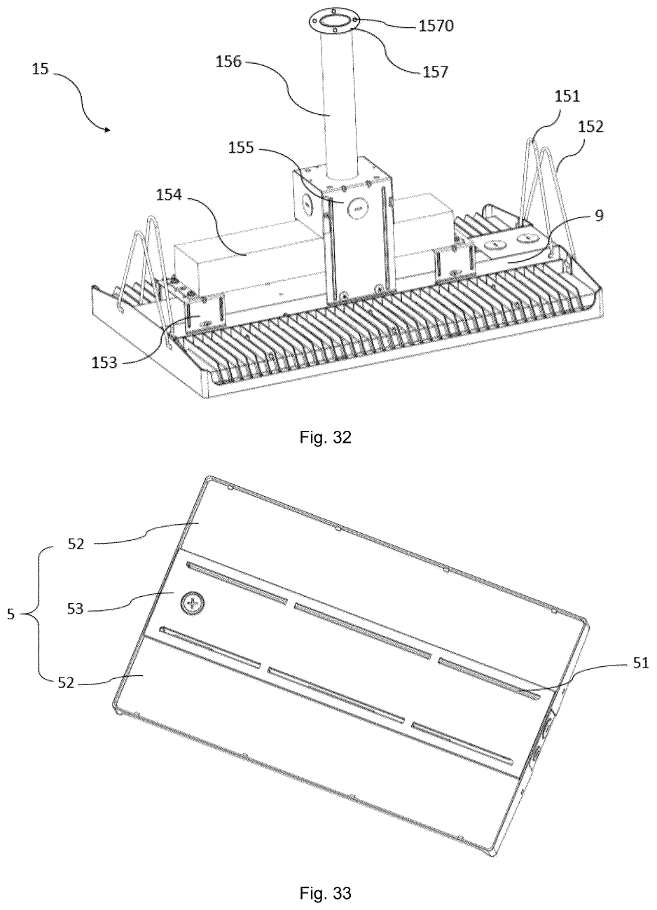

In some embodiments of the present invention, different shapes of hanging support members as shown in FIG. 28 and FIG. 31 can coexist, and the specific shape is as shown in FIG. 32. The coexistence of different shapes of hanging support members can improve the reliability of lamp fixation to a certain extent and adapt to complex fixing environments.

Referring to FIG. 33, which is a schematic diagram of a light-emitting surface of a lighting device in an embodiment of the present invention, the light-emitting surface is provided with a lampshade 5, the lampshade 5 includes a light processing element, and the light processing element includes a first optical member 52 and a second optical member 53, where the first optical member 52 and the second optical member 53 may be integrally formed or separately formed before assembly. The first optical member 52 and the second optical member 53 can be fixed by means of adhesives, screws, rivets, buckles, etc.

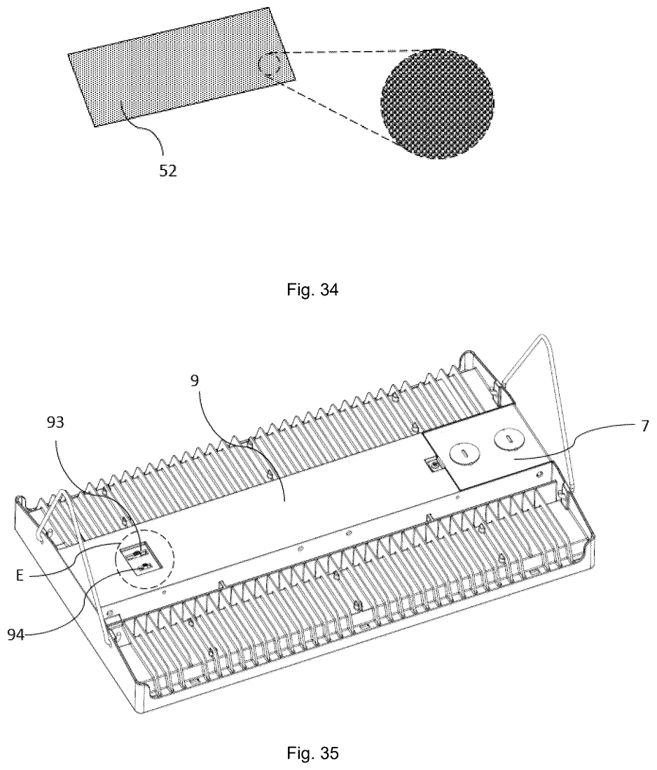

Referring to FIG. 34, which is a schematic diagram of a first optical member 52 in an embodiment of the present invention, a surface of the first optical member 52 (or the second optical member) is provided with a microstructure array, where the microstructure array may be of a micro convex or concave structure, that is, the microstructure array has a continuous undulating microstructure surface, which can diffuse and uniformize light, effectively improve the uniformity of emitted light, and prevent glare. As shown in the partial enlarged view of FIG. 34, the microstructure array is set as an array of continuously arranged micro convex lenses. Under a microstructure, there are continuous undulating light-emitting surfaces pointing in different directions on the lighting device, making the emitted light more uniform.

In some embodiments, the first optical member 52 and the second optical member 53 are provided with the same structure array.

In some embodiments, the first optical member 52 and the second optical member 53 are provided with different structure arrays.

In some embodiments, the second optical member 53 has a light guide function and can conduct the light emitted by the light-emitting element 4 in the light source mounting portion 10, such that the second optical member 53 also has certain brightness.

Referring to FIG. 35, which is a schematic back view of a lighting device in an embodiment of the present invention. As shown in the figure, the lighting device is configured with dimming and color adjustment functions, a corresponding dimming toggle button 93 and a corresponding color adjustment toggle button 94 are disposed on a connecting portion 9, and each of the dimming toggle button 93 and the color adjustment toggle button 94 can be provided with a plurality of adjustment gear positions, where the dimming toggle button 93 can control output power of the lighting device during operation to adjust the light-emitting intensity; and the color adjustment toggle button 94 can adjust an output color temperature of the lighting device, such that the lighting device can be applied to various usage environments and usage scenarios.

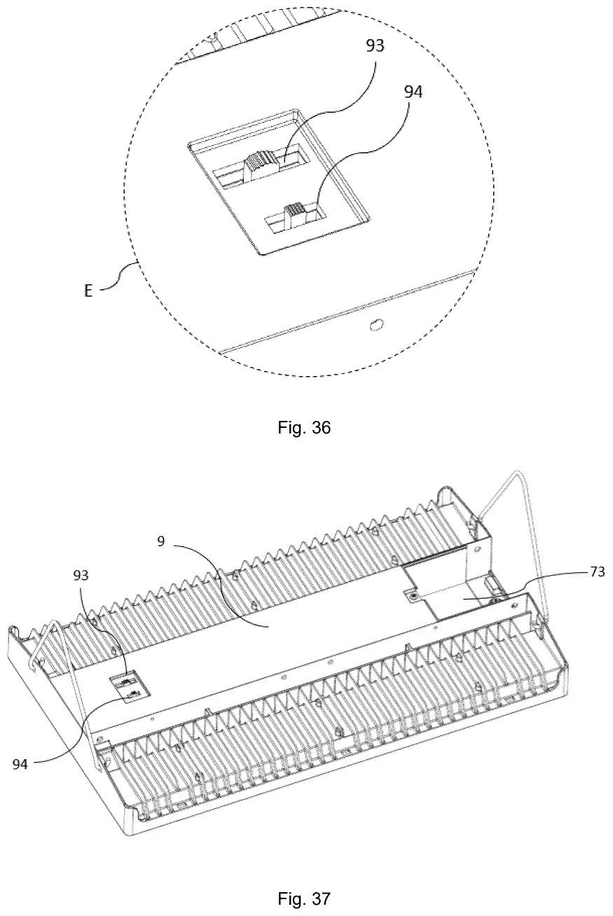

Referring to FIG. 36, which is an enlarged view of a part E in FIG. 35 of the present invention. As shown in the figure, the dimming toggle button 93 and the color adjustment toggle button 94 are both reciprocating toggle buttons, which are both slidable relative to the connecting portion 9, thereby driving an internal adjustment mechanism to control the light emitted by the lighting device. In some other embodiments of the present invention, dimming and color adjustment control of the lighting device may also be implemented by knob structures, button structures, or other similar functional components. Dimming and color adjustment may also include functions of adjusting the light intensity, adjusting the color temperature, adjusting the color of emitted light, etc.

Reference is made to FIG. 35 and FIG. 37, in which FIG. 37 is a schematic back view of a lighting device in an embodiment of the present invention. As shown in the figures, one end of the connecting portion 9 is provided with a junction box 7, the junction box 7 includes a connecting wire accommodating space 73, and the connecting wire accommodating space 73 can be used to accommodate connecting wires inside and outside the lighting device. Meanwhile, the connecting wire accommodating space 73 is used to store the connecting wires, such that the overall layout of the lighting device as a whole is more concise and orderly, and the connecting wires are prevented from being exposed to affect the service life.

In an embodiment of the present invention, the first optical member and the second optical member are provided with the same microarray structure.

In another embodiment of the present invention, the first optical member and the second optical member are provided with different microarray structures.

In another embodiment of the present invention, the first optical member and the second optical member are provided with at least one microarray structure.

While the embodiments of the present invention have been shown and described above, it can be understood that the above embodiments are exemplary and cannot be understood as a limitation to the present invention. Those of ordinary skill in the art may make changes, modifications, substitutions, variations and combinations to the above embodiments within the scope of the present invention without departing from the principle and objective of the present invention, and all these changes shall fall within the scope of protection of the claims of the present invention.

1. A lighting device, comprising:
a housing, comprising a connecting portion and at least two mounting portions, the two mounting portions disposed on two sides of the connecting portion respectively, the connecting portion has an accommodating space inside, and each of the mounting portions comprises an accommodating cavity;
at least one heat dissipation channel on at least one side of the mounting portion;
a heat dissipation portion disposed on the mounting portion, the mounting portions and the heat dissipation portion been integrally formed;
a light-emitting element, disposed in the accommodating cavity of the mounting portion, the light-emitting element and the heat dissipation portion are disposed on two sides of the mounting portion respectively;
a power supply assembly, disposed in the accommodating space of the connecting portion; and
a lampshade, covered the light-emitting element and is connected to the mounting portions;
wherein the heat dissipation channel at least partially penetrates through the housing, and is parallel to a direction of light emitted by the light-emitting element, the heat dissipation channel completely penetrates through at least part of an area of the housing, the heat dissipation portion is disposed on one side of the mounting portion facing away from the light-emitting element, at least part of gas flowing in the heat dissipation channel flows through the mounting portions, and the heat dissipation portion comprises a plurality of heat dissipation fins integrally formed with the mounting portions.

2. The lighting device according to claim 1, wherein the light-emitting element comprises a lamp board and a plurality of light-emitting bodies disposed on the lamp board.

3. The lighting device according to claim 2, wherein the lamp board is provided with a conductive circuit, and the light-emitting bodies are electrically connected to the conductive circuit.

4. The lighting device according to claim 3, wherein the mounting portion has a long edge and a short edge, and the heat dissipation channel is formed on one side of the long edge of the mounting portion.

5. The lighting device according to claim 4, wherein the heat dissipation channel is formed on at least one side of the mounting portion and along the long edge of the mounting portion.

6. The lighting device according to claim 5, wherein the heat dissipation channel is formed between the connecting portion and the mounting portion.

7. The lighting device according to claim 6, wherein the heat dissipation fins are arranged at equal intervals along a direction of the mounting portion, and a direction of a thickness of the heat dissipation fins is parallel to a length direction of the mounting portion.

8. The lighting device according to claim 7, wherein the power supply assembly is mounted on the connecting portion and supplies power to the light-emitting element.

9. The lighting device according to claim 8, further comprising a junction box, wherein the junction box is connected to the connecting portion by a connecting lug.

10. The lighting device according to claim 9, wherein the lampshade comprises a light processing unit, the light processing unit comprises a first optical member and a second optical member, same or different microstructure arrays are disposed on surfaces of the first optical member and the second optical member, and the microstructure arrays are micro convex or concave structures.

11. The lighting device according to claim 10, further comprising a hanging support member, wherein the hanging support member comprises at least one first hanging support member and at least one second hanging support member, and the first hanging support member and the second hanging support member comprise at least one arc-shaped structure.

12. The lighting device according to claim 11, further comprising a first hanging support hole on one side of the housing and a second hanging support hole on the other side of the housing, wherein the first hanging support hole is corresponding to the first hanging support member and the second hanging support hole is corresponding to the second hanging support member.

13. The lighting device according to claim 10, wherein a dimming toggle button and a color adjustment toggle button are disposed on the connecting portion, and each of the dimming toggle button and the color adjustment toggle button has a plurality of adjustment gear positions.

14. A lighting device, comprising:
a connecting portion, provided with a plurality of heat dissipation grooves;
at least two mounting portions, each comprising light source mounting portions, and the light source mounting portions are movably connected to two sides of the connecting portion;
a heat dissipation portion, comprising a plurality of heat dissipation fins integrally formed with the light source mounting portions, wherein dissipating surfaces of the heat dissipation fins are perpendicular to a light-emitting surface of the lighting device, and the dissipating surfaces of the heat dissipation fins are parallel to each other and form air flow channels;
a light-emitting element, fixed to a surface of each of the light source mounting portions, the light-emitting element comprising a lamp board and light-emitting bodies disposed on the lamp board; and
a lampshade, comprising two first optical members and a second optical member, the first optical members are disposed on two sides of the second optical member and below the light source mounting portions, and the second optical member is disposed below the connecting portion.

15. The lighting device according to claim 14, further comprising first end caps and second end caps, wherein the first end caps are fixed to two ends of the connecting portion, the second end caps are fixed to two ends of the light source mounting portion, and each of the first end caps covers at least a part of each of the second end caps.

16. The lighting device according to claim 15, wherein the first end cap comprises a rotary connecting area configured to be connected to the second end cap, and the first end cap is connected to the second end cap by a rotary fixing structure.

17. The lighting device according to claim 16, wherein the first optical members and the second optical member are independent of each other and spaced at a certain distance.

18. The lighting device according to claim 17, wherein a gap is formed between the light source mounting portion and the connecting portion, and the width of the gap is greater than or equal to (√2-1)/2 times the thickness of the light source mounting portion.

19. The lighting device according to claim 16, wherein the first end cap comprises limiting teeth and limiting grooves, a limiting pillar is disposed on the second end cap, the limiting pillar is clamped with or separated from one of the limiting grooves by pulling, and when the limiting pillar is separated from the limiting groove, the light source mounting portion is rotatable relative to the connecting portion; and when the limiting pillar is clamped with the limiting groove, the light source mounting portion is fixed relative to the connecting portion.

20. The lighting device according to claim 16, wherein the light source mounting portion comprises a mounting bottom surface and a mounting groove formed by protrusions located on two sides of the mounting bottom surface and the mounting bottom surface, a plurality of mounting tracks disposed along a length direction of the lighting device are provided on the protrusions on the two sides, each of the mounting tracks has a bent portion, and the bent portion and the mounting bottom surface form a clamping space for clamping the light-emitting element.
